(19) United States
(12) Patent Application Publication
(10) Pub. No.: US 2012/0160764 A1
(43) Pub. Date: Jun. 28, 2012

(54) POROUS VINYLIDENE FLUORIDE RESIN MEMBRANE AND PROCESS FOR PRODUCING SAME

(76) Inventors: Yasuhiro Tada, Tokyo (JP); Takeo Takahashi, Tokyo (JP)

(21) Appl. No.: 13/393,628

(22) PCT Filed: Sep. 6, 2010
(86) PCT No.: PCT/JP2010/065205

§ 371 Date: Mar. 1, 2012

(30) Foreign Application Priority Data
Sep. 4, 2009 (JP) 2009-204743
Oct. 14, 2009 (JP) 2009-237025
Oct. 14, 2009 (JP) 2009-237026

(51) Int. Cl. B01D 71/34; C02F 1/44; C08J 9/26; B01D 69/08

(52) U.S. Cl. 210/500.23; 210/500.42; 264/49

(57) ABSTRACT

A porous membrane of vinylidene fluoride resin, comprising a substantially single layer membrane of vinylidene fluoride resin having two major surfaces sandwiching a certain thickness, including a dense layer that has a small pore size and governs a filtration performance on one major surface side thereof, having an asymmetrical gradient network structure wherein pore sizes continuously increase from the one major surface side to the other opposite major surface side, and satisfying conditions: (a) the dense layer includes a 5 μm-thick portion contiguous to the one major surface showing a porosity A1 of at least 60%, (b) the one major surface shows a pore size P1 of at most 0.30 μm, and (c) the porous membrane shows a ratio Q/P1⁴ of at least 5×10⁴ (m/day·μm⁴), wherein the ratio Q/P1⁴ denotes a ratio between Q (m/day) which is a value normalized to a whole layer porosity A2=80% of a water permeation rate measured at a test length L=200 mm under the conditions of a pressure difference of 100 kPa and a water temperature of 25° C., and a fourth power P1⁴ of the pore size P1 on the one major surface. The porous membrane is produced through a process including: extruding a melt-kneaded mixture of a vinylidene fluoride resin and a plasticizer through a die into a form of a film, followed by cooling, to form a solidified film; and extracting the plasticizer to recover a porous membrane; wherein the plasticizer is mutually soluble with the vinylidene fluoride resin at a temperature forming the melt-kneaded mixture and further satisfies properties: (i) giving the melt-kneaded mixture with the vinylidene fluoride resin with a crystallization temperature Tc′ (° C.) which is lower by at least 6° C. than a crystallization temperature Tc of the vinylidene fluoride alone, (ii) giving the cooled and solidified product of the melt-kneaded mixture a crystal melting enthalpy ΔH′ (J/g) of at least 53 J/g per weight of the vinylidene fluoride resin as measured by a differential scanning calorimeter (DSC), and (iii) the plasticizer alone showing a viscosity of 200 mPa-s-1000 Pa-s at a temperature of 25° C. as measured according to JIS K7117-2 (using a cone-plate-type rotational viscometer).

### TECHNICAL FIELD

The present invention relates to a porous membrane made of a vinylidene fluoride resin, which is suitable as a membrane for separation and particularly excellent in water (filtration) treatment performance, and a process for production thereof.

### BACKGROUND ART

Vinylidene fluoride resin is excellent in chemical resistance, heat resistance and mechanical strength and, therefore, has been studied with respect to application thereof to porous membranes for separation. Many proposals have been made regarding porous membranes of vinylidene fluoride resin, for water (filtration) treatment, particularly for production of potable water or sewage treatment, and also processes for production thereof (e.g., Patent documents 1-6 listed below).

Also, the present inventors, et al., have found that a process of melt-extruding a vinylidene fluoride resin having a specific molecular weight characteristic together with a plasticizer and a good solvent for the vinylidene fluoride resin into a hollow fiber-form and then removing the plasticizer by extraction to render the hollow fiber porous is effective for formation of a porous membrane of vinylidene fluoride resin having minute pores of appropriate size and distribution and also excellent in mechanical strength, and have made a series of proposals (Patent documents 7-11 and others). However, a strong demand exists for further improvements of overall performances including filtration performances and mechanical performances of the porous membrane necessary for use as a filtration membrane. For example, as an MF (microfiltration) membrane used for the purpose of, e.g., production of potable water or industrial water by clarification of river water, etc., or clarification of sewage, it is required to have an average pore size of at most 0.25 μm for secure removal of Cryptosporidium, Escherichia coli, etc., as typical injurious micro-organisms, and causes little contamination (clogging) with organic substances on the occasion of continuous filtration operation of cloudy water, to maintain a high water permeation rate. From this viewpoint, a porous membrane proposed by Patent document 6 below has an excessively large average pore size, and a hollow-fiber porous membrane proposed by Patent document 8 retains a problem in maintenance of a water permeation rate in continuous filtration operation of cloudy water.

### PRIOR ART TECHNICAL DOCUMENTS

### Patent Documents

[Patent document 1] JP-A 63-296939
[Patent document 2] JP-A 63-296940
[Patent document 3] JP-A 3-215535
[Patent document 4] JP-A 7-173323
[Patent document 5] WO01/28667A
[Patent document 6] WO02/070115A
[Patent document 7] WO2005/099879A
[Patent document 8] WO2007/010832A
[Patent document 9] WO2008/117740A
[Patent document 10] WO2010/082437A
[Patent document 11] WO2010/090183A

### DISCLOSURE OF INVENTION

An object of the present invention is to provide a porous membrane of vinylidene fluoride resin which has a surface pore size, a water permeation rate and mechanical strength, particularly suitable for separation and particularly for water (filtration) treatment, and also shows good water-permeation-rate maintenance performance, even when applied to continuous filtration of cloudy water, and also a process for production thereof.

Being provided for achieving the above-mentioned object, the porous membrane of vinylidene fluoride resin of the present invention, is a substantially single layer membrane of vinylidene fluoride resin having two major surfaces sandwiching a certain thickness, includes a dense layer that has a small pore size and governs a filtration performance on one major surface side thereof, has an asymmetrical gradient network structure wherein pore sizes continuously increase from the one major surface side to the other opposite major surface side, and satisfies conditions (a) to (c) shown below:

(a) the dense layer includes a 5 μm-thick portion contiguous to the one major surface showing a porosity A1 of at least 60%,
(b) the one major surface shows a pore size P1 of at most 0.30 μm, and
(c) the porous membrane shows a ratio Q/P1⁴ of at least 5×10⁴ (m/day·μm⁴), wherein the ratio Q/P1⁴ denotes a ratio between Q (m/day) which is a value normalized to a whole layer porosity A2=80% of a water permeation rate measured at a test length L=200 mm under the conditions of a pressure difference of 100 kPa and a water temperature of 25° C., and a fourth power P1⁴ of said pore size P1 on the one major surface.

As a part of study for achievement of the above-mentioned object, the present inventors made a continuous filtration test (of which the details will be described later) by the MBR (membrane bioreactor) process (more specifically, an activated sludge process assisted by membrane separation) as a practical test for evaluating the performance in continuous filtration of cloudy water, with respect to various hollow-fiber porous membranes of vinylidene fluoride resin including those disclosed in the above-mentioned Patent documents 7-11. The evaluation was performed in terms of a critical filtration flux which is defined as a maximum filtration flux giving a differential pressure rise of at most 0.133 kPa after 2 hours of membrane filtration treatment as a practical evaluation standard of water-permeation-rate maintenance power, and investigated a correlation of the evaluation result with the pore size distributions on the outer and inner surfaces and porosity, etc., of the porous membranes. As a result, it has been found that, among the type of vinylidene-fluoride-resin porous membranes including a dense layer which governs filtration performance on the side of water to be treated and a sparse layer which contributes to reinforcement on the side of permeated water, and having an asymmetrical gradient network texture including pore sizes which increase continuously from the side of the water to be treated to the side of the permeated water, porous membranes exhibiting lager critical filtration fluxes necessarily have a smaller surface pore size on the side of the water to be treated and a large porosity of dense layer contiguous to the side of water to be treated. As a result, a porous membrane of vinylidene fluoride resin almost achieving the above-mentioned object has been proposed (Patent document 11).

However, it has been found that the vinylidene fluoride resin porous membrane according to Patent document 11 is caused to have a comparatively thick dense layer to result in a difficulty that a ratio Q/P1⁴, which shows a water permeation performance while maintaining a minute particle removal performance, is liable to decrease (after-mentioned Comparative Examples 1-3). On the other hand, the present invention has succeeded in preventing the thickening of the dense layer to attain an improvement in Q/P1⁴, while retaining the above-mentioned characteristics of the membrane of Patent document 11.

In order to realize the above-mentioned structural characteristics of the vinylidene-fluoride-resin porous membrane, it is very important to select a plasticizer forming the melt-kneaded composition before cooling by melt-kneading with a vinylidene fluoride resin. In Patent document 11, it has been considered preferable to use a relatively large amount of plasticize that has a mutual solubility with vinylidene fluoride resin under heating (at a melt-kneading composition-forming temperature) and provides the melt-kneaded composition with a crystallization temperature Tc′ (° C.) which is almost equal to the crystallization temperature Tc (° C.) of the vinylidene-fluoride-resin alone, to carry out the melt-kneading with a vinylidene fluoride resin of high-molecular weight, and to cool the resultant film-like material from one side thereof for solidification of the film, followed by extraction of the plasticizer, to provide a porous membrane with an asymmetrical gradient-network-texture. Moreover, it is undesirable to use a large amount of good solvent of a vinylidene fluoride resin that has been used in order to promote homogeneous mixing with film-starting-material resin and a plasticizer as used in Patent documents 7-10, etc. and has a mutual solubility with a cooling fluid, as it lowers the crystallization temperature of the melt-kneaded composition and causes a difficulty in control of a surface pore size. In the above, the Tc′ of the melt-kneaded composition almost equal to Tc has been adopted based on a concept of maintaining a large difference Tc′-Tq to cause phase separation at the time of cooling, thereby forming a dense solidified layer of vinylidene fluoride resin, wherein a relatively large amount of plasticizer is finely dispersed in proximity to the film surface. However, it has been found that the above measure also caused the chilling effect to reach from the outer surface even to the inside of the membrane simultaneously, thus resulting in the thickening of the dense solidified layer. From this viewpoint, it is rather preferred that the plasticizer gives Tc′ lower than Tc. According to further study of the present inventors, it has been found that even a melt-kneaded mixture having a Tc′ lower than Tc can provide a dense solidified layer (dense layer) of vinylidene fluoride resin wherein a relatively large amount of plasticizer is finely dispersed in proximity to the film surface if the melt-kneaded mixture can provide a solidified product showing a large crystal melting enthalpy per unit weight of vinylidene fluoride resin. Moreover, it has been also found preferable that the plasticizer has a large viscosity to some extent so that the plasticizer once distributed in the dense solidified layer according to phase separation may not be exuded out toward an adjacent inner layer which has not been solidified yet to result in a lowering in porosity of the dense layer.

The process for producing a vinylidene fluoride resin porous membrane according to the present invention is based on the above-described finding and, more specifically, comprises: extruding a melt-kneaded mixture of a vinylidene fluoride resin and a plasticizer through a die into a form of a film, followed by cooling, to form a solidified film; and extracting the plasticizer to recover a porous membrane;

wherein the plasticizer is mutually soluble with the vinylidene fluoride resin at a temperature forming the melt-kneaded mixture and further satisfies properties (i) to (iii) shown below:

(i) giving the melt-kneaded mixture with the vinylidene fluoride resin with a crystallization temperature Tc′ (° C.) which is lower by at least 6° C. than a crystallization temperature Tc of the vinylidene fluoride alone,
(ii) giving the cooled and solidified product of the melt-kneaded mixture a crystal melting enthalpy ΔH′ (J/g) of at least 53 J/g per weight of the vinylidene fluoride resin as measured by a differential scanning calorimeter (DSC), and
(iii) the plasticizer alone showing a viscosity of 200 mPa-s-1000 Pa-s at a temperature of 25° C. as measured according to JIS K7117-2 (using a cone-plate-type rotational viscometer).

### BRIEF DESCRIPTION OF THE DRAWINGS

FIG. 1 is a schematic illustration of an apparatus for evaluating water permeability of hollow-fiber porous membranes obtained in Examples and Comparative Examples.

FIG. 2 is a schematic illustration of an apparatus for evaluating critical filtration flux by the MBR process of hollow-fiber porous membranes obtained in Examples and Comparative Examples.

### BEST MODE FOR PRACTICING THE INVENTION

The porous membrane of the present invention can be formed in either a planar membrane or a hollow-fiber membrane, but may preferably be formed in a hollow-fiber membrane which can enlarge the membrane area per unit volume of filtration apparatus, particularly water filtration treatment.

Hereafter, the porous membrane of vinylidene fluoride resin, principally in a hollow-fiber form, of the present invention will be described in the order of the production process of the present invention which is a preferred process for production thereof.

(Vinylidene Fluoride Resin)

The vinylidene fluoride resin used as a principal starting material of the membrane in the present invention may be homopolymer of vinylidene fluoride, i.e., polyvinylidene fluoride, or a copolymer of vinylidene fluoride together with a monomer copolymerizable with vinylidene fluoride, or a mixture of these, having a weight-average molecular weight of preferably 6×10⁵ to 12×10⁵, more preferably 6.5×10⁵ to 10×10⁵, particularly preferably 7×10⁵ to 9×10⁵. Examples of the monomer copolymerizable with vinylidene fluoride may include: tetrafluoroethylene, hexafluoropropylene, trifluoroethylene, chlorotrifluoroethylene and vinylidene fluoride, which may be used singly or in two or more species. The vinylidene fluoride resin may preferably comprise at least 70 mol % of vinylidene fluoride as the constituent unit. Among these, it is preferred to use homopolymer consisting of 100 mol % of vinylidene fluoride in view of its high crystallization temperature Tc (° C.) and high mechanical strength.

A vinylidene fluoride resin of a relatively high molecular weight as described above may preferably be obtained by emulsion polymerization or suspension polymerization, particularly preferably by suspension polymerization.

The vinylidene fluoride resin forming the porous membrane of the present invention may preferably have a good crystallinity, as represented by a difference Tm2−Tc of at most 32° C., preferably at most 30° C., further preferably at most 28° C., most preferably below 25° C., between an inherent melting point Tm2 (° C.) and a crystallization temperature Tc (° C.) of the resin as determined by DSC measurement in addition to the above-mentioned relatively large weight-average molecular weight of at least 6×10⁵.

Herein, the inherent melting point Tm2 (° C.) of resin should be distinguished from a melting point Tm1 (° C.) determined by subjecting a procured sample resin or a resin constituting a porous membrane as it is to a temperature-increase process according to DSC. More specifically, a vinylidene fluoride resin procured generally exhibits a melting point Tm1 (° C.) different from an inherent melting point Tm2 (° C.) of the resin, due to thermal and mechanical history thereof received in the course of its production or heat-forming process, etc. The melting point Tm2 (° C.) of vinylidene fluoride resin defining the present invention defined as a melting point (a peak temperature of heat absorption according to crystal melting) observed in the course of DSC re-heating after once subjecting a procured sample resin to a prescribed temperature increase and decrease cycle in order to remove the thermal and mechanical history thereof, and details of the measurement method will be described prior to the description of Examples appearing hereinafter.

The vinylidene fluoride resin satisfying the condition of Tm2−Tc≦32° C. may preferably be provided as a mixture formed by blending 25-98 wt. %, preferably 50-95 wt. %, further preferably 60-90 wt. % of a vinylidene fluoride resin having a weight-average molecular weight of 4.5×10⁵-10×10⁵, preferably 4.9×10⁵-9.0×10⁵, further preferably 6.0×10⁵-8.0×10⁵, as a medium-to-high molecular weight matrix vinylidene fluoride resin (PVDF-I) and 2-75 wt. %, preferably 5-50 wt. %, further preferably 10-40 wt. %, of a crystallinity modifier vinylidene fluoride resin of an ultra-high-molecular weight (PVDF-II) having a weight-average molecular weight that is at least 1.4 times that of PVDF-I and below 1.5×10⁶, preferably below 1.4×10⁶, further preferably below 1.3×10⁶, wherein each vinylidene fluoride resin is selected from the above-mentioned species of the vinylidene fluoride resins. Of these, the medium-to-high molecular-weight component functions as a so-called matrix resin for keeping a high molecular weight level as a whole of the vinylidene fluoride resin and providing a hollow-fiber porous membrane with excellent strength and water permeability. On the other hand, the ultrahigh molecular weight component, combined with the above-mentioned medium-to-high molecular-weight component, raises the crystallization temperature Tc of the starting resin (generally about 140° C. for vinylidene fluoride resin alone), and raises the viscosity of the melt-extrusion composition to reinforce it, thereby allowing stable extrusion in the hollow-fiber form, in spite of a high plasticizer content. In the process of the present invention, on the occasion of the cooling and solidification of a film-form melt-kneaded mixture, the cooled side is quenched, and the inner portion to the opposite side is gradually cooled due to a cooling speed gradient to form an inclined pore size distribution in the thicknesswise direction of the film. Based on this general process feature, in the process of the present invention, a plasticizer providing a lower Tc′ of the melt-kneaded mixture to retard the crystallization for most of the film thickness, thereby preventing the thickening of the resultant dense layer, while maintaining (not changing) the cooling temperature required for providing a desirable surface pore size on the smaller pore side-surface. However, the inner to the opposite surface portion, subjected to the gradual cooling, is liable to result in spherulites of vinylidene fluoride resin, which lead to a decrease in mechanical strength, a decrease in water permeability, and an inferior stretchability. In the present invention, however, even under such a gradual cooling, the generation of spherulites can be effectively suppressed by addition of the ultrahigh molecular weight component. The ultrahigh molecular weight component is considered to act as a crystalline nucleus agent, to result in a rise of the crystallization temperature Tc of the vinylidene fluoride resin alone, but this is not contradictory with the use of a plasticizer lowering Tc′ of the melt-kneaded mixture for the purpose of increasing the relative crystallization speed delay of the inner film portion relative to the cooled side. Tc is preferably at least 143° C., further preferably at least 145° C., most preferably in excess of 148° C. Generally, Tc of the vinylidene fluoride resin used does not substantially change in the production process of a hollow fiber. Therefore, it can be measured by using a product hollow-fiber porous membrane as a sample according to the DSC method described later.

If the Mw of the ultra-high molecular weight vinylidene fluoride resin (PVDF-II) is less than 1.4 times the Mw of the medium-to-high molecular weight resin(PVDF-I), it becomes difficult to fully suppress the growth of spherulites, and if the Mw is 1.5×10⁶ or higher on the other hand, it becomes difficult to uniformly disperse it in the matrix resin.

Both vinylidene fluoride resins of a medium-to-high molecular weight and an ultra-high molecular weight as described above, may preferably be obtained by emulsion polymerization or suspension polymerization, particularly preferably by suspension polymerization.

Moreover, if the addition amount of the ultra-high molecular weight vinylidene fluoride resin is less than 2 wt. %, the effects of spherulite suppression and viscosity-increasing and reinforcing the melt-extrusion composition are not sufficient, and in excess of 75 wt. %, there result in increased tendencies such that the texture of phase separation between the vinylidene fluoride resin and the plasticizer becomes excessively fine to result in a porous membrane exhibiting a lower water permeation rate when used as a microfiltration membrane, and the stable film or membrane formation becomes difficult due to melt fracture during the processing.

In the production process of the present invention, a plasticizer is added to the above-mentioned vinylidene fluoride resin, to form a starting composition for formation of the membrane.

### (Plasticizer)

The hollow-fiber porous membrane of the present invention is principally formed of the above-mentioned vinylidene fluoride resin, but for the production thereof, it is preferred to use at least a plasticizer for vinylidene fluoride resin as a pore-forming agent in addition to the vinylidene fluoride resin. The plasticizer preferably used in the present invention is one which is mutually soluble with the vinylidene fluoride resin at the melt-kneading temperature and further satisfies properties (i) to (iii) shown below.

(i) giving the melt-kneaded mixture with the vinylidene fluoride resin with a crystallization temperature Tc′ (° C.) which is lower by at least 6° C., preferably by at least 9° C., further preferably by 12° C. or more, than a crystallization temperature Tc (° C.) of the vinylidene fluoride alone,

(ii) giving the cooled and solidified product of the melt-kneaded mixture a crystal melting enthalpy ΔH′ (J/g) of at least 53 J/g, preferably at least 55 J/g, further preferably 58 J/g or more, per weight of the vinylidene fluoride resin as measured by a differential scanning calorimeter (DSC), and

(iii) the plasticizer alone showing a viscosity of 200 mPa-s-1000 Pa-s, preferably 400 mPa-s-100 Pa-s, further preferably 500 mPa-s-10 Pa-s, at a temperature of 25° C. as measured according to JIS K7117-2 (using cone-plate-type rotational viscometer).

A preferred examples of plasticizers may be a polyester plasticizer comprising a (poly)ester, i.e., a polyester or an ester (inclusive of a mono- or di-glycol ester of an aliphatic dibasic acid), which has at least one terminal, preferably both terminals, capped with a monobasic aromatic carboxylic acid.

As a dibasic acid component forming a body of the above-mentioned polyester plasticizer, it is preferred to use an aliphatic dibasic acid having 4-12 carbon atoms. Examples of such aliphatic dibasic acids may include: succinic acid, maleic acid, fumaric acid, glutamic acid, adipic acid, azelaic acid, sebacic acid, and dodecanedicarboxylic acid. Among these, aliphatic dibasic acids having 6-10 carbon atoms are preferred so as to provide a polyester plasticizer with good mutual solubility with vinylidene fluoride resin, and adipic acid is particularly preferred in view of its commercial availability. These aliphatic dibasic acids may be used alone or in combination of two or more species thereof.

As a glycol component forming the body (central portion) of the above-mentioned polyester plasticizer, it is preferred to use a glycol having 2-18 carbon atoms, and examples thereof may include: aliphatic dihydric alcohols, such as ethylene glycol, 1,2-propylene glycol, 1,2-butanediol, 1,3-butanediol, 1,4-butanediol, 2-methyl-1,3-propanediol, neopentyl glycol, 1,5-pentanediol, 1,6-hexanediol, 2,2-diethyl 1,3-propanediol, 2,2,4-tri-methyl-1,3-pentanediol, 2-ethyl-1,3-hexanediol, 1,9-nonanediol, 1,10-decanediol, 2-butyl-2-ethyl-1,5-propanediol, and 1,12-octadecanediol; and polyalkylene glycols, such as diethylene glycol and dipropylene glycol., are mentioned. Particularly, glycols having 3-10 carbon atoms may preferably be used. These glycols may be used alone or in combination of two or more species thereof.

The above-mentioned polyester plasticizer preferably has a molecular chain of which a terminal is capped with a monobasic aromatic carboxylic acid. Examples of such a monobasic aromatic carboxylic acid may include: benzoic acid, toluic acid, dimethylaromatic mono-carboxylic acid, ethylaromatic monocarboxylic acid, a cumin acid, tetramethylaromatic monocarboxylic acid, naphthoic acid, biphenylcarboxylic acid, and furoic acid. These may be used alone or in combination of two or more species thereof. Because of easiness for commercial availability, benzoic acid is particularly preferred.

In the present invention, the plasticizer as a whole (referring to components other than the vinylidene fluoride resin in the melt-kneaded mixture) can include a monomeric plasticizer or a water-insoluble solvent in addition to the above-mentioned polyester plasticizer as long as the above-mentioned characteristics (i)-(iii) are satisfied. A preferred example of such a monomeric plasticizer may be a dibenzoate-type monomeric plasticizer formed of a glycol and an aromatic monobasic carboxylic acid. The glycol and the aromatic monobasic carboxylic acid may be similar to those contained in the above-mentioned polyester plasticizer. The water-insoluble solvent may be a solvent which is immiscible with water and shows a dissolving power of at least 0.1 g/ml at 200° C. for the vinylidene fluoride resin, such as propylene carbonate.

Referring to the viscosity of the plasticizer shown in the above-mentioned condition (iii), a viscosity below 200 mPa-s is liable to result in a lower porosity of the dense layer, and also a lowering in melt viscosity of the melted mixture of the vinylidene fluoride resin and the plasticizer, leading to a difficulty in stably taking out the melted mixture discharged out of the die. The tendency becomes pronounced particularly in the case of forming into a hollow-fiber form. A polyester plasticizer as described above is also preferred in the case of adding a large amount of plasticizer to the vinylidene fluoride resin in order to provide an adequately high melt viscosity to the melted mixture, thus stabilizing the forming thereof.

As for the degree of polymerization of the polyester plasticizer, it preferably has a number-average molecular weight of at most 10,000, more preferably at most 5000, most preferably 2000 or less. If the number-average molecular weight exceed 10,000, the crystallization of the vinylidene fluoride resin is liable to be obstructed to result in a lower ΔH′ and a difficulty in phase separation at a low temperature. Generally, as an index of the degree of polymerization of the polyester plasticizer, a viscosity measured at a temperature of 25° C. based on JIS K7117-2 (using a cone-plate type rotational viscometer) is used in many cases, and it is preferably at most 1000 Pa-s, further preferably at most 100 Pa-s, most preferably 10 Pa-s or lower.

As a result of selection of such a preferred plasticizer, it has become possible to add a large amount of the plasticizer to the above-mentioned vinylidene fluoride resin having a preferred molecular weight characteristic and realize a separation into a vinylidene fluoride resin phase and a plasticizer phase in the solidified product after extrusion and cooling, and also a high porosity of dense layer after removal of the plasticizer phase in the subsequent extraction step.

In the present invention, the polyester plasticizer is required to have a mutual solubility with the vinylidene fluoride resin to such an extent that it provides a melt-kneaded mixture which is clear (that is, it does not leave a material giving a turbidity recognizable with naked eyes) when melt-kneaded with vinylidene fluoride resin by means of an extruder. However, the formation of a melt-knead mixture by means of an extruder includes factors, such as mechanical conditions, other than those originated from starting materials, so that the mutual solubility is judged according to a mutual solubility evaluation method as described later is used in the present invention in order to eliminate such other factors.

(Composition)

The starting material composition for forming a porous-membrane may preferably comprise: 20-50 wt. %, preferably 25-wt. %, of vinylidene fluoride resin, and 50-80 wt. %, preferably 60-75 wt. %, of a plasticizer. The optional ingredients, such as a monomeric plasticizer, a water-insoluble solvent, etc., may be used in consideration of the melt viscosity under melt-kneading of the material composition, etc., in such a manner as to replace a portion of the plasticizer. (The whole components other than the vinylidene fluoride resin forming the melt-kneaded mixture, inclusive of such optional components in addition to the plasticizer, may be referred to as the “plasticizer, etc.” sometimes hereafter.)

If the amount of the plasticizer is too small, it becomes difficult to achieve an increased porosity of the dense layer as an object of the present invention, and if too large, the melt viscosity is lowered excessively, thus being liable to result in collapse of hollow fiber film in the case of forming a hollow-fiber membrane and also lower mechanical strengths of the resultant porous membrane.

The addition amount of the plasticizer may be adjusted within the above-mentioned range, so as to provide a Tc′ of the melt-kneaded mixture with the vinylidene fluoride resin of 120-140° C., preferably 125-139° C., further preferably 130-138° C. Below 120° C., the crystal melting enthalpy ΔH′ of the melt-kneaded mixture is lowered to result in a lower porosity A1 of the dense layer, or, in the case of a hollow fiber, the solidification in a cooling bath may become insufficient to cause collapse of the hollow fiber. If it exceeds 140° C., the thickening prevention effect of the dense layer becomes insufficient.

(Mixing and Melt-Extrusion)

The melt-extrusion composition at a barrel temperature of 180-250° C., preferably 200-240° C., may be extruded into a hollow-fiber film by extrusion through a T-die or an annular nozzle at a temperature of generally 150-270° C., preferably 170-240° C. Accordingly, the manners of mixing and melting of the vinylidene fluoride resin, and the plasticizer, etc., are arbitrary as far as a uniform mixture in the above-mentioned temperature range can be obtained consequently. According to a preferred embodiment for obtaining such a composition, a twin-screw kneading extruder is used, and the vinylidene fluoride resin (preferably in a mixture of a principal resin and a crystallinity-modifier resin) is supplied from an upstream side of the extruder and the plasticizer, etc., are supplied at a downstream position to be formed into a uniform mixture until they pass through the extruder and are discharged. The twin-screw extruder may be provided with a plurality of blocks capable of independent temperature control along its longitudinal axis so as to allow appropriate temperature control at respective positions depending on the contents of the materials passing therethrough.

(Cooling)

Then, the melt-extruded hollow-fiber film is cooled preferentially from an outside thereof and solidified by introducing it into a cooling liquid bath containing a liquid (preferably water) that is inert (i.e., non-solvent and non-reactive) to vinylidene fluoride resin, at a temperature Tq which is lower by 50-140° C., preferably 55-130° C., further preferably 60-110° C., than the crystallization temperature of the melt-extruded film. If Tc′-Tq is less than 50° C., it becomes difficult to form a porous membrane which has a small pore size on the treated water-side surface and an inclined pore size distribution aimed at by the present invention. Moreover, in order to provide the temperature difference exceeding 140° C., it is generally necessary for the liquid temperature for cooling to be less than 0° C., and the use of an aqueous medium as a preferred cooling liquid becomes difficult. The cooling bath temperature Tq is preferably 0-90° C., more preferably 5-80° C., further preferably 25-70° C. In this instance, if a hollow-fiber film is cooled while an inert gas, such as air or nitrogen, is injected into the hollow part thereof, a hollow-fiber film having an enlarged diameter can be obtained. This is advantageous for obtaining a hollow-fiber porous membrane which is less liable to cause a lowering in water permeation rate per unit area of the membrane even at an increased length of the hollow-fiber membrane (WO2005/03700A). For the formation of a planar film, the cooling from one side thereof can be effected by showering with a cooling liquid or cooling by means of a chill roll. In order to prevent the collapse of a melt-extruded hollow-fiber film, it is preferred to take a time after the melt-extrusion and before entering the cooling bath (i.e., an air gap passage time=air gap/melt-extrudate take-up speed), which is generally 0.3-10.0 sec., particularly 0.5-5.0 sec.

(Extraction)

The cooled and solidified film is then introduced into an extraction liquid bath to remove the plasticizer, etc. therefrom. The extraction liquid is not particularly restricted provided that it does not dissolve the vinylidene fluoride resin while dissolving the plasticizer, etc. Suitable examples thereof may include: polar solvents having a boiling point on the order of 30-100° C., inclusive of alcohols, such as methanol and isopropyl alcohol, and halogenated solvents, such as dichloromethane and 1,1,1-trichloroethane.

A halogenated solvent has an ability of swelling a vinylidene fluoride resin, and shows a large extraction effect of the plasticizer. Because of its swelling ability, however, the membrane after the extraction tends to cause shrinkage of pores formed by extraction of the plasticizer if the membrane is transferred as it is to a subsequent drying step. Accordingly, the melt-extruded and solidified film after cooling and extraction of the plasticizer with a halogenated solvent, is preferably subjected to drying, after replacing the halogenated solvent, e.g., by dipping, within a solvent which does not have an ability of swelling the vinylidene fluoride resin. The judgment as to whether a certain solvent has the ability of swelling a vinylidene fluoride resin can be effected as described below. Examples of the solvent of non-swelling ability may include: isopropyl alcohol, ethanol, hexane, etc., but these are not exhaustive as long as the following evaluation standard is met.

<Method of Evaluating Swelling Ability>

A 0.5-mm-thick press sheet is produced by heat-pressing for 5 minutes at a temperature of 230° C. and cooling solidification with a cooling press at a temperature of 20° C. The press sheet is cut out to form a 50 mm-square test piece. The test piece after being measured at W1, is dipped in a solvent at room temperature for 120 hours. The test piece is then taken out to wipe off the solvent attached to the surface thereof with a filter paper, and then weighed at W2. A swelling rate (%) is calculated according to formula below. It is estimated that it does not have swelling ability if the swelling rate is less than 1%, and that it has swelling ability if it is 1% or more.

Swelling rate(%)=(W2−W1)/W1×100.

<<Extraction Rinsing Method>>

The above-described extraction rinsing method (that is a method wherein a membrane of vinylidene fluoride resin containing a halogenated solvent in its pores is once dipped, etc., in a solvent which does not have swelling ability to vinylidene fluoride resin for replacing the halogenated solvent is then dried) is applicable to formation of either a planar membrane or a hollow-fiber membrane provided that such a membrane of vinylidene fluoride resin (b) containing a halogenated solvent in its pores has been produced in advance thereof, e.g., by the thermally induced phase separation method using a halogenated solvent as an extracting solvent, or by the non-solvent-induced phase separation method using a halogenated solvent as the non-solvent. If any thing, however, the extraction rinsing method may rather preferably be applied to a membrane of vinylidene fluoride resin (b) containing a halogenated solvent prepared through the thermally induced phase separation method preferably using a halogenated solvent for effectively extracting an organic liquid. Furthermore, the extraction rinsing method may preferably be applied to formation of a hollow-fiber membrane which can easily provide a large membrane area per unit volume of filtration apparatus when used as a membrane for water filtration treatment.

While it is a general practice to perform stretching after extraction of the organic liquid with a halogenated solvent as will be mention later, the stretching can also be performed before extraction of the organic liquid with a halogenated solvent. In the latter case, the effect of increasing a water permeation rate through a porosity increase and a pore size expansion, becomes smaller compared with the case of stretching after extraction, whereas this is advantageous that it allows a continuous operation from the extrusion of a hollow-fiber film to the stretching. In the case of forming a hollow-fiber membrane, it is adequate that the stretching ratio is preferably 1.4 to 5.0 times, more preferably 1.6 to 4.0 times, most preferably 1.8 to 3.0 times. The stretching temperature is similar to the case of after-extraction stretching.

Such a process for producing a vinylidene fluoride resin porous membrane including the “extraction rinsing method” as generally described above may be characterized as (1)-(8) below.

(1) A process for producing a vinylidene fluoride resin porous membrane, comprising: forming a film product (a) of a mixture of a vinylidene fluoride resin and an organic liquid, dipping the film product (a) within a halogenated solvent to remove the organic liquid to form a membrane of vinylidene fluoride resin (b) containing the halogenated solvent within pores formed by removal of the organic liquid, dipping the membrane of vinylidene fluoride resin (b) without substantial drying thereof within a solvent having no swelling ability to vinylidene fluoride resin for replacing the halogenated solvent, and then drying the membrane.
(2) A production process according to (1) above, wherein the film product (a) is a solidified film product formed by cooling a melt-kneaded mixture of the vinylidene fluoride resin and the organic liquid to cause phase separation and solidification.
(3) A production process according to (2) above, wherein the film product (a) has a crystal melting enthalpy of at least 53 J/g per unit weight of the vinylidene fluoride resin as measured by differential scanning calorimetry (DSC).
(4) A production process according to any of (1) to (3) above, wherein the mixture of the vinylidene fluoride resin and the organic liquid forming the film product (a) contains at least 200 volume parts of the organic liquid per 100 volume parts of the vinylidene fluoride resin.
(5) A production process according to any of (1) to (4) above, wherein the organic liquid is a polyester plasticizer.
(6) A production process according to any of (1) to (5) above, wherein the halogenated solvent provides a swelling rate of 2-20 wt. % to the vinylidene fluoride resin.
(7) A production process according to any of (1) to (6) above, wherein the product porous membrane shows a porosity giving a pore-forming efficiency of at least 0.85 in terms of a ratio of the porosity to the volume content of the organic liquid in the mixture of the vinylidene fluoride resin and the organic liquid forming the film product (a).
(8) A production process according to any of (1) to (3) above, including a stretching step before the extraction with a halogenated solvent, or after replacement of the halogenated solvent with the solvent which does not have swelling ability to vinylidene fluoride resin and drying.

(Stretching)

The film or membrane after the extraction may preferably be subjected to stretching in order to increase the porosity and pore size and improve the strength-elongation characteristic thereof. It is particularly preferred to selectively wet the film or porous membrane after extrusion down to a certain depth from the outer surface thereof, prior to the stretching, and then effect the stretching in this state (which may be hereinafter referred to as “partially wet stretching”), for the purpose of attaining a high porosity A1 of dense layer. More specifically, prior to the stretching, the porous membrane is wetted to a certain depth of at least 5 μm, preferably at least 7 μm, further preferably at least 10 μm and at most ½, preferably at most ⅓, further preferably ¼ or less, of the membrane thickness. A wet depth of less than 5 μm is insufficient for an increase of dense layer porosity A1, and a wet depth in excess of ½ is liable to result in uneven drying of the wetting liquid during dry heat relaxation after the stretching, thus leading to uneven heating and relaxation effect.

The reason why the above-mentioned partially wet stretching is effective for providing an increased dense layer porosity A1 has not been clarified as yet but is adduced as follows by the present inventors. During a longitudinal stretching, a compression force acts in a thicknesswise direction, and as a result of wetting to a certain depth from the outer surface, (a) thermal conduction within a heating bath is improved to alleviate a temperature gradient in the dense layer and reduce the compression forth in the thickness direction, and (b) the pores are filled with the liquid so that the pores are not readily collapsed even if the thicknesswise compression force is applied thereto.

<<Partially Wet Stretching Method>>

As is understood from the above-mentioned explanation, the “partially wet stretching method” is basically characterized principally by a stretching step applied to a resin porous membrane which has been already formed and in a dry state, and is not essentially restricted to a particular type and a particular process by which the resin porous membrane is produced. The method is applicable to either a hollow-fiber membrane or a planar membrane. Moreover, the resin forming the porous membrane can be either a hydrophilic resin or a hydrophobic resin, and either a natural resin or a synthetic resin. However, if durability is concerned in case where the porous membrane is used as a separation membrane for treating an aqueous solution, the resin may preferably be insoluble in water. Representative examples of such a water-insoluble resin may include: polyolefin resins (as described in, e.g., JP46-40119B, JP50-2176B), polyvinylidene fluoride resins (e.g., JP63-296940A, JP03-215535A, WO99/47593A, WO003/031038A, WO2004/081109A, WO2005/099879A, JP2001-179062A, JP2003-210954A), polytetrafluoroethylene resin, polysulfone resin, polyether sulfone resin (WO02/058828A1), polyvinyl chloride resin, polyarylene sulfide resin, polyacrylonitrile resin, cellulose acetate resin (JP2003-311133A), etc., and these may also be used as preferable resin materials in the present invention.

Application to the porous membrane made of vinylidene fluoride resin which has chemical resistance, weather resistance, and heat resistance, in combination, is the most preferred, especially. Such a vinylidene fluoride resin porous membrane is generally produced in many cases through (A) a process wherein a mixture of a vinylidene fluoride resin and an organic liquid which are mutually soluble at least at an elevated temperature, is cooled to form a film product of the vinylidene fluoride resin containing the organic liquid phase-separated from the vinylidene fluoride resin, and the organic liquid is then removed from the film to leave a porous membrane (thermally induced phase separation process; as described in WO99/47593A, WO03/031038A, WO2004/081109A, WO2005/099879A, JP2001-179062A); or (B) a process wherein a film product of a mixture of a vinylidene fluoride resin and an organic liquid as described above is contacted with a non-solvent which is non-solvent for vinylidene fluoride resin but is mutually soluble with the organic liquid to cause phase separation between the organic liquid and the vinylidene fluoride resin while replacing the organic liquid with the non-solvent to form a membrane of vinylidene fluoride resin containing the non-solvent (non-solvent-induced phase separation process; JP63-296940A and JP2003-210954A); or (C) a process wherein a vinylidene fluoride resin, an organic liquid which is mutually insoluble with the vinylidene fluoride resin and an inorganic fine particles are shaped into a film, form which the organic liquid and the inorganic fine particles are removed by extraction to recover a porous membrane (JP03-215535A), and the method of the present invention can be applied to membranes which have been produced through any of the above-mentioned processes.

Although the partially wet stretching method can be applied to either a planar membrane or a hollow-fiber membrane as mentioned above, for water filtration treatment, a hollow-fiber membrane which can provide a large membrane area per unit volume of a filtration apparatus is preferred, and as separators for electrochemical devices as represented by batteries, a planar membrane is preferred. Such a process for producing a stretched resin porous membrane including the “partially wet stretching method” as generally described above may be characterized as (1)-(14) below.

(1) A process for producing a stretched resin porous membrane, comprising: stretching a resin porous membrane of which a surface portion down to a depth which is at least 5 μm from an outer surface and at most ½ of the thickness is selectively wetted with a wetting liquid.
(2) A production process according to (1) above, wherein the stretching is performed while the porous membrane is selectively wetted with respect to a surface portion down to a depth which is at least 7 μm from an outer surface and at most ½ of the thickness is selectively wetted with a wetting liquid.
(3) A production process according to (1) or (2) above, wherein the resin porous membrane having a porosity of at least 50% is stretched.
(4) A production process according to any of (1) to (3) above, wherein the resin porous membrane is an asymmetrical membrane having two major surfaces having different pore sizes, and only a smaller pore size-side surface is wetted.
(5) A production process according to any of (1) to (4) above, wherein the stretching is performed at a ratio of at least 1.5 times.
(6) A production process according to any of (1) to (5) above, wherein the resin porous membrane comprises a hydrophobic resin.
(7) A production process according to any of (1) to (5) above, wherein the resin porous membrane comprises a vinylidene fluoride resin.
(8) A production process according to (6) or (7) above, wherein the wetting liquid comprises an aqueous solution.
(9) A production process according to (8) above, wherein the wetting liquid comprises an aqueous surfactant solution.
(10) A production process according to (8) above, wherein the wetting liquid comprises an aqueous solution of a polyglycerine fatty acid ester.
(11) A production process according to any of (1) to (10) above, wherein the resin porous membrane after the stretching has a surface pore size of at most 0.5 μm on its smaller pore size-side surface.
(12) A production process according to any of (1) to (11) above, wherein the resin porous membrane after the stretching has an average pore size of at most 0.5 μm as measured according to the half-dry method.
(13) A production process according to any of (1) to (12) above, wherein the stretching temperature is 25-90° C.
(14) A production process according to any of (1) to (13) above, including, after the stretching step, a relaxation step within a liquid or gas which does not wet the resin porous membrane.

Hereinbelow, an embodiment wherein a vinylidene fluoride resin porous membrane in a hollow-fiber form formed by the thermally induced phase separation method is subjected to the partially wet stretching method, is described step by step, whereas it would be easily understood to one of ordinary skill in the art that the embodiment can be applied to various forms and materials of resin porous membranes including planar membranes formed in the conventional method with some alterations of conditions.

As a specific method for wetting down to a certain depth from an outer surface, it is possible to apply a solvent wetting vinylidene fluoride resins, such as methanol and ethanol, or an aqueous solution thereof selectively to the outer surface of the porous-membrane. However, in order to provide a selective applicability to the outer surface of a vinylidene-fluoride-resin porous membrane, the application of (inclusive of application by dipping within) a wettability promoter liquid having a surface tension of 25-45 mN/m is preferred. A surface tension less than mN/m provides an excessively fast penetration to the PVDF porous membrane, thus being liable to make difficult the selective application of the wettability promoter liquid onto the outer surface, and a surface tension exceeding 45 mN/m is liable to cause the wettability promoter liquid to be repelled by the outer surface of the PVDF porous membrane, thus making difficult the uniform application of the liquid onto the outer surface, because of insufficient wettability or penetrability to the PVDF porous membrane. It is particularly preferred to use a surfactant liquid (i.e., an aqueous solution or aqueous homogeneous dispersion liquid of a surfactant) obtained by adding a surfactant into water as such a wettability promoter liquid. The type of surfactant is not particularly limited, and examples thereof may include: anionic surfactants inclusive of carboxylate salt type, such as an aliphatic-monocarboxylic-acid salt, sulfonic acid type, such as an alkylbenzene sulfonate, sulfate type, such as an alkyl sulfate salt, and phosphate type, such as a phosphoric acid alkyl salt; cationic surfactants, inclusive of amine salt type, such as an alkylamine salt, and quaternary ammonium salt type, such as an alkyl trimethyl-ammonium salt; nonionic surfactants, inclusive of ester types, such as a glycerin fatty acid ester, ether type, such as polyoxyethylene alkyl phenyl ether, ester ether type, such as polyethylene glycol fatty acid ester; amphoteric surfactants inclusive of carboxy betaine type, such as N,N-dimethyl-N-alkyl betaine aminoacetate, and glycin type, such as 2-alkyl 1-hydroxyethyl-carboxymethyl-imidazolinium betaine, etc. Poly-glycerin fatty acid esters are particularly preferably used as wettability promoter liquids which are free from hygienic problem even if they finally remain in the product porous membrane

The surfactant may preferably be one having an (hydrophile-lipophilie balance) of 8 or more. At an HLB of less than 8, the surfactant is not finely dispersed in water, so that it becomes difficult to effect uniform wettability promotion. A particularly preferred class of surfactants may include: nonionic surfactants or ionic (anionic, cationic, amphoteric) surfactants having an HLB of 8-20, further preferably 10-18, and a nonionic surfactant is especially preferred.

In many cases, the application of the wettability promoter liquid to the porous-membrane outer surface, may preferably be performed by batchwise or continuous dipping of the porous membrane. The dipping treatment functions as an application on both surfaces for a planar membrane and an application on a single surface for a hollow-fiber membrane. The batch dipping treatment of a planar membrane may be applied to a pile of sheets cut in appropriate sizes, and the batch dipping treatment of a hollow-fiber membrane is performed by dipping of the hollow-fiber membrane wound about a bobbin or the like. In the case of batch processing, it is preferred to form relatively large emulsion particles by using a surfactant with a relatively low HLB in the above-mentioned range, more specifically an HLB of 8-13. The continuous processing is performed by continuously feeding and passing an elongated membrane through a treating liquid, both in the case of planar membrane and a hollow-fiber membrane. In case of applying only to one side of a planar membrane, spraying of a treatment solution is also used preferably. In the case of continuous processing, it is preferred to form relatively small emulsion particles by using a surfactant with a relatively high HLB in the above-mentioned range, more specifically an HLB of 8-20, more preferably 10-18.

Although there is no particular limitation in the viscosity of a wettability promoter liquid, it is possible to moderately retard the penetration speed by providing the wettability promoter liquid with a higher viscosity or to accelerate the penetration rate by using a lower viscosity, depending on the manner of applying a wettability promoter liquid.

Although there is no particular restriction in the temperature of the wettability promoter liquid, it is possible to moderately retard the penetration speed by using a lower temperature of wettability promoter liquid or to use a higher temperature to accelerate the penetration speed, depending on the manner of applying a wettability promoter liquid. Thus, the viscosity and temperature of the wettability promoter liquid can act in mutually opposite directions and can be complementarily controlled for adjustment of the penetration rate of the wettability promoter liquid.

The stretching of a hollow-fiber membrane may preferably be effected as a uniaxial stretching in the longitudinal direction of the hollow-fiber membrane by means of, e.g., a pair of rollers rotating at different circumferential speeds. This is because it has been found that a microscopic texture including a stretched fibril portion and a non-stretched node portion appearing alternately in the stretched direction is preferred for the hollow-fiber porous membrane of vinylidene fluoride resin of the present invention to exhibit a harmony of porosity and strength-elongation characteristic thereof. The stretching ratio may suitably be on the order of 1.1-4.0 times, particularly about 1.2-3.0 times, most preferably about 1.4-2.5 times. If the stretching ratio is excessively large, the hollow-fiber membrane can be broken at a high liability. The stretching temperature may preferably be 25-90° C., particularly 45-80° C. At too low a stretching temperature, the stretching becomes nonuniform, thus being liable to cause the breakage of the hollow-fiber membrane. On the other hand, at an excessively high temperature, enlargement of pore sizes cannot be attained even at an increased stretching ratio, so that it becomes difficult to attain an increased water permeation rate. In the case of a planar membrane, it is also possible to effect successive or simultaneous biaxial stretching. It is also preferred to heat-treat the porous membrane for 1 sec.-18000 sec., preferably 3 sec.-3600 sec., in a temperature range of 80-160° C., preferably 100-140° C., to increase the crystallinity in advance of the stretching for the purpose of improving the stretchability.

(Relaxation Treatment)

The hollow-fiber porous membrane of vinylidene fluoride resin obtained through the above-mentioned steps may preferably be subjected to at least one stage, preferably at least two stages, of relaxation or fixed length heat treatment in a non-wetting environment (or medium). The non-wetting environment may be formed of non-wetting liquids having a surface tension (JIS K6768) larger than a wet tension of vinylidene fluoride resin, typically water, or almost all gases including air as a representative. The relaxation may be effected by passing a hollow-fiber porous membrane stretched in advance through the above-mentioned non-wetting, preferably heated environment disposed between an upstream roller and a downstream roller rotating at successively decreasing circumferential speeds. The relaxation percentage determined by (1−(the downstream roller circumferential speed/the upstream roller circumferential speed))×100(%) may preferably be totally 0% (fixed-length heat treatment) to 50%, particularly 1-20% of relaxation heat treatment. A relaxation percentage exceeding 20% is difficult to realize or, even if possible, can only result in a saturation or even a decrease of the effect of increasing the water permeation rate, while it may somewhat depend on the stretching ratio in the previous step, so that it is not desirable.

The first stage relaxation temperature may preferably be 0-100° C., particularly 50-100° C. The relaxation treatment time may be either short or long as far as a desired relaxation percentage can be accomplished. It is generally on the order of from 5 second to 1 minute but need not be within this range.

A latter stage relaxation treatment temperature may preferably be 80-170° C., particularly 120-160° C., so as to obtain a relaxation percentage of 1-20%.

The effect of the above-mentioned relaxation treatment is an increase in water permeation rate of the resultant hollow-fiber porous membrane, while substantially retaining a sharp pore size distribution. If the above-mentioned treatment is performed at a fixed length, it becomes a heat-setting after stretching.

(Porous Membrane of Vinylidene Fluoride Resin)

The porous membrane according to the present invention obtained through the above-mentioned series of steps comprises a substantially single layer of vinylidene fluoride resin having two major surfaces sandwiching a certain thickness, and has a pore size distribution including a dense layer that has a small pore size and governs a filtration performance on one major surface side thereof, having an asymmetrical gradient network structure wherein pore sizes continuously increase from the one major surface side to the other opposite major surface side, and characterized by conditions shown below:

(a) the dense layer includes a 5 μm-thick portion contiguous to the one surface showing a porosity A1 of at least 60%, preferably at least 65%, further preferably at least 70% (the upper limit thereof is not particularly limited but a porosity A1 exceeding 85% is generally difficult to realize),
(b) the one major surface shows a surface pore size P1 of at most 0.30 μm, preferably at most 0.25 μm, more preferably at most 0.20 μm, most preferably 0.15 μm or smaller (the lower limit thereof is not particularly limited but P1 below 0.01 μm is generally difficult to realize), and
(c) the porous membrane shows a ratio Q/P1⁴ of at least 5×10⁴ (m/day·μm⁴), preferably at least 7×10⁴ (m/day·μm⁴), more preferably at least 1×10⁵ (m/day·μm⁴), wherein the ratio Q/P1⁴ denotes a ratio between Q (m/day) which is a value normalized to a whole layer porosity A2=80% of a water permeation rate measured at a test length L=200 mm under the conditions of a pressure difference of 100 kPa and a water temperature of 25° C., and a fourth power P1⁴ of said pore size P1 on the one major surface. (The upper limit thereof is not particularly limited but a it is generally difficult to realize the ratio exceeding 5×10⁵ (m/day·μm⁴));
(d) the ratio A1/P1 between the porosity A1 and the treated water-side surface pore size P1 (um) is at least 400, preferably at least 500, further preferably 550 or more (the upper limit thereof is not particularly limited but a ratio exceeding 1000 is generally difficult to realize);
(e) the ratio A1/A2 of between A1 and the whole layer porosity A2 is at least 0.80, preferably at least 0.85, more preferably 0.90 or more (as for upper limit, a ratio exceeding 1.0 is generally difficult to realize);
(f) the dense layer thickness is generally at least 7 μm and at most 40 μm, preferably at most 30 μm, more preferably at most 20 μm, most preferably 15 μm or less; and
(g) moreover, the inclined pore size distribution of the porous membrane of the present invention is preferably represented by a ratio P2/P1 of 2.0-10.0 between the surface pore size P1 (μm) on the one major surface and the surface pore size P2 (μm) on the opposite side major surface.

The above-mentioned feature (a) of the dense layer being at least 60% means that the dense layer which governs the separation performance of the porous membrane of the present invention has a high porosity; the feature (b) of the surface pore size P1 on the one major surface being at most 0.30 μm means that the particle removal performance of the porous membrane of the present invention is high; and the feature (c) of the ratio Q/P1⁴ being at least 5×10⁴ (m/day-um⁴) shows that the particle removal performance and the water permeability are satisfied in a good balance.

Other general features of the porous membranes of the present invention, when formed in a hollow-fiber form, may include: an average pore size Pm of generally at most 0.25 μm, preferably 0.20-0.01 μm, more preferably 0.15-0.05 μm; a maximum pore size Pmax of generally 0.70-0.03 μm, preferably 0.40-0.06 μm, respectively as measured by the half-dry/bubble point method (ASTM-F 316-86 and ASTM-E 1294-86); a tensile strength of at least 7 MPa, preferably at least 8 MPa; and an elongation at break of at least 70%, preferably at least 100%. The thickness is ordinarily in the range of 50-800 μm, preferably 50-600 μm, particularly preferably 150-500 μm. The outer diameter in the form of a hollow fiber may suitably be on the order of 0.3-3 mm, particularly about 1-3 mm. A hollow-fiber membrane may exhibit a pure water permeability of at least 20 m/day, preferably at least 30 m/day, more preferably 40 m/day or more, as measured at a test length of 200 mm, a temperature of 25° C., and a pressure difference of 100 kPa, and may exhibit a normalized water permeability Q normalized to a whole layer porosity A2=80% of at least 20 m/day, preferably at least 30 m/day, further preferably 40 m/day or more.

### EXAMPLES

Hereinbelow, the present invention will be described more specifically based on Examples and Comparative Examples. The properties described herein including those described below, except for those for which the measurement methods have been described above, are based on measured values according to the following methods.

(Crystalline Melting Points Tm1, Tm2, Crystal Melting Enthalpy and Crystallization Temperatures Tc, Tc′)

A differential scanning calorimeter “DSC-7” (made by Perkin-Elmer Corp.) was used. A sample resin of 10 mg was set in a measurement cell, and in a nitrogen gas atmosphere, once heated from 30° C. up to 250° C. at a temperature-raising rate of 10° C./min., then held at 250° C. for 1 min. and cooled from 250° C. down to 30° C. at a temperature-lowering rate of 10° C./min., thereby to obtain a DSC curve. On the DSC curve, an endothermic peak temperature in the course of heating was determined as a melting point Tm1 (° C.), and a heat of absorption by the endothermic peak giving Tm1 was measured as a crystal melting enthalpy. Further, an exothermic peak temperature in the course of cooling was determined as a crystallization temperature Tc(° C.). Successively thereafter, the sample resin was held at 30° C. for 1 min., and re-heated from 30° C. up to 250° C. at a temperature-raising rate of 10° C./min. to obtain a DSC curve. An endothermic peak temperature on the re-heating DSC curve was determined as an inherent melting point Tm2 (° C.) defining the crystallinity of vinylidene fluoride resin in the present invention.

Further, for the measurement of a crystallization temperature Tc′ (° C.) of a mixture of a vinylidene fluoride resin and a plasticizer etc., as a film starting material, a sample comprising 10 mg of a first intermediate form obtained by melt-kneading through an extruder and extruded out of a nozzle, followed by cooling and solidification, was subjected to a temperature raising and lowering cycle identical to the one described above to obtain a DSC curve, on which an exothermic temperature in the course of cooling was detected as a crystallization temperature Tc′ (° C.) of the mixture.

The crystallization temperature Tc of a vinylidene fluoride resin does not substantially change throughout the process for producing the porous membrane according to the present invention. In this specification, 10 mg of a product membrane, i.e., a membrane finally obtained through the extraction step, optionally further the stretching step and the relaxation step, is representatively taken as a sample and subjected to the above-mentioned heating and cooling cycle to obtain a DSC curve, on which an exothermic temperature in the course of cooling is taken as a measured value.

(Crystal Melting Enthalpy ΔH′ of the Melt-Kneaded Mixture in the Cooled and Solidified State)

Crystal melting enthalpy ΔH′ of a mixture of vinylidene fluoride resin and a plasticizer as a membrane-forming starting material was measured as follows.

10 mg of a melt-kneaded mixture after cooling and solidification was subjected to a heating and cooling cycle similar to the one used for measurement of above-mentioned crystallization temperature Tc′ to obtain a DSC curve, from which an endothermic peak area for the first heating was used to calculate a crystal melting enthalpy ΔH0 (J/g) for a whole mass of the melt-kneaded mixture after cooling and solidification. Separately from the above, about 1 g of the above-mentioned melt-kneaded mixture in the cooled and solidified state was weighed at W0 (g). Then weighed melt-kneaded mixture in the cooled and solidified state was subjected to an operation including dipping in dichloromethane and 30 minutes of washing under application of ultrasonic wave at room temperature, and this operation was repeated totally 3 times to extract the plasticizer, etc., followed by drying in an oven at a temperature of 120° C. and weighing. The measured weight at W (g) was used to calculate a crystal melting enthalpy ΔH′ (J/g) of the melt-kneaded mixture in the cooled and solidified state as a value per unit weight of the vinylidene fluoride resin according to the following formula.

ΔH′=ΔH0/(W/W0)

For a sample of such a melt-kneaded mixture in the cooled and solidified state, it is convenient to use a cooled and solidified film of a melt-kneaded mixture before extraction produced in an actual process (a first intermediate form in Examples described hereafter).

(Mutual Solubility)

A mutual solubility of a plasticizer, etc., with vinylidene fluoride resin was evaluated in the following manner:

23.73 g of vinylidene fluoride resin and 46.27 g of a plasticizer are mixed at a room temperature, to obtain a slurry mixture. Then, a barrel of a mixer (“LABO-PLASTOMILL” Mixer Type “R-60”, made by Toyo Seiki K.K.) is set to a prescribed temperature which is higher than the melting point of the vinylidene fluoride resin by 10° C. or more (e.g., by 17-37° C.), and the above slurry mixture is fed to the mixer and melt-kneaded therein at mixer rotation speed of 50 rpm. In case where the mixture becomes clear (to such an extent that it does not leave a material giving turbidity recognizable with naked eyes) within 10 minutes, the plasticizer is judged to be mutually soluble with the vinylidene fluoride resin. In some cases, the melt-kneaded mixture can be viewed opaque due to entanglement of bubbles, e.g., because of a high viscosity of the melt-kneaded mixture. In such a case, the judgment should be made after evacuation as by heat pressing, as required. In case where the mixture is solidified by cooling, the mixture is heated again into a melted state to effect the judgment.

(Weight-Average Molecular Weight (Mw))

A GPC apparatus (“GPC-900”, made by Nippon Bunko K.K.) was used together with a column of “Shodex KD-806M” and a pre-column of “Shodex KD-G” (respectively made by Showa Denko K.K.), and measurement according to GPC (gel permeation chromatography) was performed by using NMP as the solvent at a flow rate of 10 ml/min. at a temperature of 40° C. to measure polystyrene-based molecular weights.

(Whole Layer Porosity A2)

An apparent volume V (cm³) of a porous membrane (either a planar membrane or a hollow-fiber membrane) was calculated, and also a weight W (g) of the porous membrane was measured, to determine the whole layer porosity A2 from the following formula:

Whole layer porosity A2(%)=(1−W/(V×ρ))×100 [Formula 1]
μ: Specific gravity of PVDF (=1.78 g/cm³).

Incidentally, a ratio A0/RB between a non-stretched whole layer porosity A0 measured in a similar manner as above with respect to a membrane after extraction but before stretching and a proportion RB (wt. %) of a mixture B of a plasticizer (and a solvent, if any) in the melt-extruded composition, is taken to roughly represent a pore-forming efficiency of the mixture B.

(Pore-Forming Efficiency)

A volume-basis mixing ratio RL of an organic liquid (plasticizer, etc.) in a mixture thereof with a vinylidene fluoride resin (specific gravity=1.78) as a film-forming material was calculated from the specific gravity and an extrusion supply ratio (wt. %) of the organic liquid. The pore-forming efficiency was calculated as a ratio A0/RL between RL and the whole layer porosity A0.

(Size Shrinkability)

A first intermediate form before extraction obtained in Examples or Comparative Examples described hereafter was cut into a sample length of about 300 mm, and the sample was subjected to measurement of a before-extraction length L0 (mm), a before-extraction outer diameter OD0 (mm), a before-extraction inner diameter ID0 (mm) and a before-extraction film thickness T0 (mm). Then, the sample was subjected to prescribed operations of extraction, substitution and drying, and the sample was then subjected to measurement of an after-drying length L1 (mm), an after-drying outer diameter OD1 (mm), an after-drying inner diameter ID1 (mm) and an after-drying film thickness T1 (mm). Respective size shrinkabilities (%) were calculated by formula below:

Length shrinkability(%)=100×(L0−L1)/L0

Outer diameter shrinkability(%)=10×(OD0−OD1)/OD0

Inner diameter shrinkability(%)=100×(ID0−ID1)/ID0

Film-thickness shrinkability(%)=100×(T0−T1)/T0

(Average Pore Size)

An average pore size Pm (μm) was measured according to the half dry method based on ASTM F316-86 and ASTM E1294-89 by using “PERMPOROMETER CFP-2000AEX” made by Porous Materials, Inc. A perfluoropolyester (trade name “Galwick”) was used as the test liquid.

(Maximum Pore Size)

A maximum pore size Pmax (μm) was measured according to the bubble-point method based on ASTM F316-86 and ASTM E1294-89 by using “PERMPOROMETER CFP-2000AEX” made by Porous Materials, Inc. A perfluoropolyester (trade name “Galwick”) was used as the test liquid.

(Surface Pore Size P1 on the Side of Water-to-be-Treated And Surface Pore Size P2 on the Permeated Water Side)

A porous-membrane sample (of either planar or t hollow-fiber form) was subjected to measurement of an average pore size P1 on the water-to-be-treated side surface (an outer surface with respect to a hollow fiber) and an average pore size P2 on the permeated water side surface (an inner surface with respect to a hollow fiber) by the SEM method (SEM average pore size). Hereafter, a measurement method is described with respect to a hollow-fiber porous-membrane sample for an example. About the outer surface and inner surface of a hollow-fiber membrane sample, SEM-photographs are respectively taken at an observation magnification of 15,000 times. Next, each SEM photograph is subjected to measurement of pore sizes with respect to all recognizable pores. A major axis and a minor axis are measured for each pore, and each pore size is calculated according to a formula of: pore size=(major-axis+minor axis)/2. An arithmetic mean of all the measured pore size, is take to determine an outer surface average pore size P1 and an inner-surface average pore size P2, respectively. Incidentally, in case where too many pores are observed in a taken photographic image, it is possible to divide the photographic image into four equal areas and performing the above-mentioned pore size measurement with respect to one area (¼ picture). In the case where the pore size measurement is performed based on a ¼ picture with respect to an outer surface of the hollow-fiber membrane of the present invention, the number of examined pores will be roughly about 200 to 300.

(Dense Layer Thickness)

About a porous-membrane sample (of a planar or hollow-fiber form), the thickness of a layer contiguous to the surface on the water-to-be-treated side (the outer surface for a hollow fiber) in which a pore size is almost uniform, is measured by a cross-sectional observation through a SEM. Hereafter, a measuring method is described with reference to a hollow-fiber porous-membrane sample. A hollow-fiber porous-membrane sample is first dipped in isopropyl alcohol (IPA) to be impregnated with IPA, then immediately dipped in liquid nitrogen to be frozen, and bent in the frozen state, to expose a cross-section perpendicular to the longitudinal direction thereof. The exposed cross-section is sequentially SEM-photographed at an observation magnification of 15,000 times from the outer surface side to the inner surface side. Next, pore sizes are measured about all recognizable pores in a 3 μm×3 μm-square region around a point of 1.5 μm from the outer surface with the center on the outermost SEM photograph. A major axis and a minor axis are measured for each pore, and each pore size is calculated according to a formula of: pore size=(major-axis+minor axis)/2. An arithmetic mean of all the measured pore sizes, is taken as a cross-sectional pore size X_{1.5} (μm) at a depth of 1.5 μm. Then, with respect to a 3 μm×3 μm-square region shifted by 3 μm toward the inner surface side, an arithmetic mean pore size is obtained, similarly as above. This sequential determination of cross-sectional pore sizes is continued to obtain a cross-sectional pore size X_{d} (μm) at an arbitrary depth of d μm from the outer surface. If the condition X_{d}/X_{1.5}≦1.2 is satisfied, it is assumed to represent a uniform pore size, and a maximum depth d (μm) satisfying the condition is taken as a dense layer thickness with a uniform pore size.

(Dense Layer Porosity)

A porous-membrane sample (of either a planar or hollow-fiber form) is subjected to measurement of a porosity A1 of a 5 μm-thick portion contiguous to the water-to-be-treated side surface (hereinafter referred to as a “dense layer porosity A1”) is measured by an impregnation method. Hereafter, a measurement method is described with respect to a hollow-fiber porous-membrane sample for an example. First, a hollow-fiber porous-membrane sample is cut in a length L=about 300 mm, both ends of a hollow part thereof are sealed by heat-pressure bonding or with an adhesive, and the weight W0 (mg) thereof is measured. Then, the both end-sealed hollow-fiber membrane sample is dipped in a test liquid of glycerin (“Refined glycerin D”, made by Lion K.K.) containing 0.05 wt. % of a dye (“Cation Red”, made by Kiwa Kagaku Kogyo K.K.) and about 0.1 wt. % of fatty acid glycerol ester (“MO-7S” made by Sakamoto Yakuhin Kogyo K.K.; HLB value=12.9) and taken out, followed by wiping-out of the test liquid on the surface and further weighing at W (mg). Subsequently, the sample after the weighing is sliced with a razor into a ring, of which the portion impregnated (i.e., dyed) with the test liquid is measured at a thickness t (μm). Impregnation thickness t is adjusted to t=5±1 (μm) by adjusting the dipping time in the test liquid and the aliphatic glycerol ester concentration in the test liquid. The volume V (ml) of the sample portion impregnated with the test liquid is calculated by the following formula based on the outer diameter OD of the above-mentioned sample (mm), length L (mm), and impregnation thickness t (μm):

V=π×((OD/2)²−(OD/2−t/1000)²)×L/1000

A volume VL (ml) of the impregnating test liquid is calculated by the following formula from the difference between the weight W0 (mg) of the sample before dipping and the weight W (mg) of the sample after dipping:

VL=(W−W0)/(ρs×1000)

Wherein ρs denotes a specific gravity of test liquid and is 1.261 (g/ml).

A dense layer porosity A1 (%) is calculate by the following formula:

A1=VL/V×100.

(Water Permeability F, Normalized Water Permeability Q)

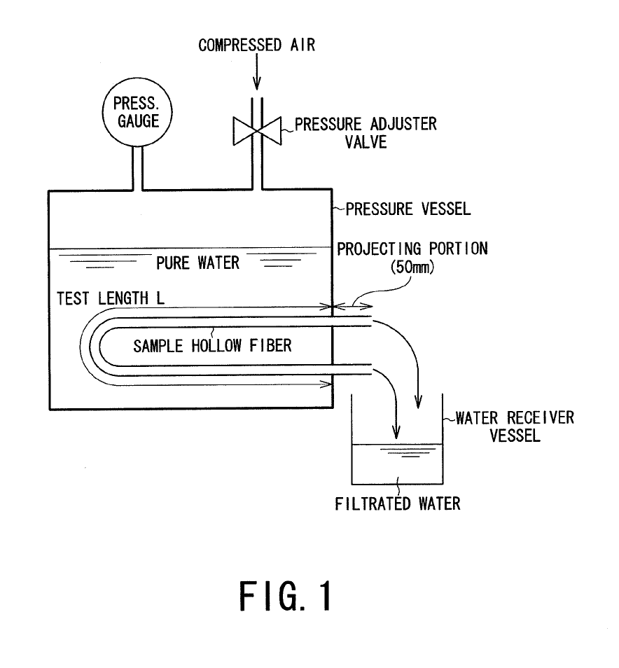

A sample hollow-fiber porous membrane having a test length L (as shown in FIG. 1)=200 mm was immersed in ethanol for 15 min., then immersed in water to be hydrophilized, and then subjected to a measurement of water permeation rate per day (m³/day) at a water temperature of 25° C. and a pressure difference of 100 kPa, which was then divided by a membrane area of the hollow-fiber porous membrane (m²) (=outer diameter×π×test length L) to provide a water permeation rate. The resultant value is indicated, e.g., as F (100 kPa, L=200 mm), in the unit of m/day (=m³/m²·day).

A normalized pure water permeability Q normalized to a whole layer porosity A1=80% was calculated by a formula of Q=F×80/A2 based on the measured whole layer porosity A2 (%).

(Critical Filtration Flux According to the MBR Process)

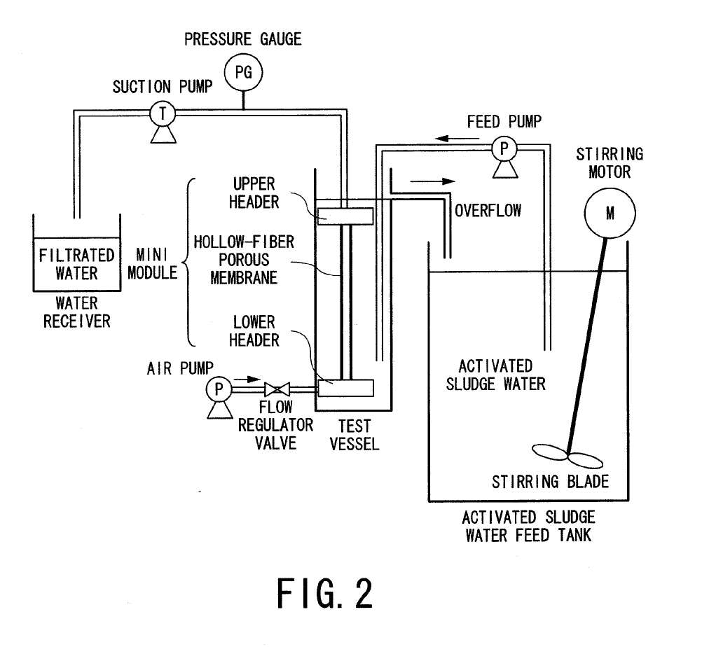

In a test apparatus as shown in FIG. 2, an immersion-type mini-module formed from a hollow-fiber porous-membrane sample is subjected to continuous filtration of activated sludge water while increasing the filtration fluxes (m/day) every 2 hours, to measure an average differential pressure increase rate for each filtration flux. A maximum filtration flux at which the differential pressure increase rate does not exceed 0.133 kPa/2 hours is defined as critical filtration flux (m/day).

The mini module is formed by fixing two hollow-fiber porous-membrane samples vertically so as to provide an effective filtration length per fiber of 500 mm between an upper header and a lower header. The upper header is equipped with upper insertion slots for fixing open upper ends of hollow-fiber membranes at a lower part thereof, an internal space (flow path) for filtrated water communicative with the upper insertion slots, and a filtrated water exit for discharging the filtrated water at an upper part thereof. The lower header has lower insertion slots for fixing closed lower ends of the hollow-fiber membranes at an upper part thereof, 10 aeration nozzles of 1 mm in diameter not communicative with the lower insertion slots, an internal space (supply path) for supplying air to the aeration nozzles, and an air supply port for supplying air to the internal space. The upper and lower ends of the two hollow-fiber membrane samples are inserted into the upper slots and lower slots, respectively, and fixed liquid-tight with the upper header and in a closed state with the lower header, respectively with an epoxy resin.

The module-forming hollow-fiber membrane samples are immersed in ethanol for 15 minutes and rinsed with water to be wetted, and then immersed vertically at an almost central part within a rectangular test water vessel measuring a bottom area of about 30 cm² and retaining a water level of 600 mm. On the other hand, to the test water vessel, an activated sludge water or slurry containing MLSS (mixed liquor suspended solids) of 8600 mg/L and a dissolved organic content DOC (measured as a TOC (total organic content) after filtration with 1-μm glass filter) of 7-9 mg/L accommodated in a feed water tank with an internal volume of 20 L, is supplied at a rate of 0.2 L/with a pump, and an overflow is circulated back to the feed water tank. Further, from the lower header, air is supplied at a rate of 5 L/min. to cause continual bubbling in the activated sludge water in the test vessel.

In this state, a suction pump is operated to suck from the filtration water exit of the upper header to effect a cycle including 13 minute of a suction filtration operation for 13 minutes from the exterior to the inside of the hollow-fiber membranes at a fixed filtration water rate and 2 minute of a pause period, thereby measuring changes in pressure difference between the outside and the inside of the hollow-fiber membranes. The filtration test is continued at a fixed filtration water rate, which is initially set at 0.3 m/day as filtration flux (m/day) and is thereafter increased every 2 hours by an increment of 0.1 m/day, until the difference pressure increase rate exceeds 0.133 kPa/2 hours. If the difference pressure increase rate exceeds 0.133 kPa/2 hours in a cycle, a water permeation rate (that is lower by 0.1 m/day than that in the cycle) is recorded as a critical filtration flux (m/day).

(Surface Tension Measurement)

A surface tension of a wetting promoter liquid was measured by using a Du Nouy surface tension meter by the ring method according to JIS-K3362.

(Critical Surface Tension)

Water and ethanol were mixed at different ratios to prepare aqueous solutions having different surface tensions. As for the relation between ethanol concentration and surface tension, a disclosure in Chemical Engineering Handbook (Revised 5th. Edition, published from Maruzen Co., Ltd.) was referred to. In the above-mentioned measurement of water permeability, in place of the wetting of porous membrane by ethanol, wetting was performed using the above-mentioned aqueous solutions, and a pure water permeability F′ (m/day) (=m³/m²/day) was repeatedly measured. A maximum of surface tensions of the aqueous solutions giving a ratio a ratio F′/F of 0.9 or more with a pure water permeability F measured after wetting with ethanol alone is defined as a critical surface tension of a porous membrane. Incidentally, hollow-fiber porous membranes of vinylidene fluoride resin obtained in Examples A1-A5 described hereafter were evaluated to show a critical-surface-tension γc of 38 mN/m.

(Tensile Test)

A tensile tester (“RTM-100”, made by Toyo Baldwin K.K.) was used for measurement in the atmosphere of a temperature of 23° C. and 50% of relative humidity, under the conditions including an initial sample length of 100 mm and a crosshead speed of 200 mm/min.

### Example 1

A matrix vinylidene fluoride resin (PVDF-I) (powder) having a weight-average molecular weight (Mw) of 6.6×10⁵ and a crystallinity modifier vinylidene fluoride resin (PVDF-II) (powder) having Mw=9.7×10⁵ were blended in proportions of 75 wt. % and 25 wt. %, respectively, by a Henschel mixer to obtain a PVDF mixture having Mw=7.4×10⁵ (Mixture A, crystallization temperature after being formed into a membrane=148.3° C.).

As a plasticizer, a polyester plasticizer (polyester of a dibasic acid and glycol having a terminal capped with adipic acid, “W-83” made by DIC Corporation; number-average molecular weight=about 500, a viscosity at 25° C. of 750 mPa-s as measured by a cone-plate rotational viscometer according to JIS K7117-2) was used.

An equi-directional rotation and engagement-type twin-screw extruder (“TEM-26SS”, made by Toshiba Kikai K.K.; screw diameter: 26 mm, L/D=60) was used, and Mixture A was supplied from a powder supply port to be melt-kneaded at a barrel temperature of 220° C., the plasticizer was supplied at a Mixture A/Plasticizer ratio of 27.0 wt. %/73.0 wt. % from a liquid supply port downstream of the powder supply port to melt-kneaded at a barrel temperature of 220° C., and the melt-kneaded product was extruded through a nozzle (at 190° C.) having an annular slit of 6 mm in outer diameter and 4 mm in inner diameter into a hollow fiber-form extrudate. In this instance, air was injected into a hollow part of the fiber through an air supply port provided at a center of the nozzle so as to adjust an inner diameter of the extrudate.

The extruded mixture in a molten state was introduced into a cooling bath of water maintained at 50° C. and having a surface 280 mm distant from the nozzle (i.e., an air gap of 280 mm, Tq=50° C.) to be cooled and solidified (at a residence time in the cooling bath of about 6 sec.), pulled up at a take-up speed of 3.8 m/min. and wound up about a bobbin to obtain a first intermediate form.

Then, the first intermediate form was immersed in dichloromethane at room temperature for 30 min. to extract the plasticizer, while rotating the bobbin so as to impregnate the fiber evenly with dichloromethane. Then, the extraction was repeated under the same condition by replacing the dichloromethane with a fresh one to effect totally 3 times of extraction.

Next, first intermediate form containing dichloromethane, in a state before drying (i.e., a state where whitening is not visually observed in the first intermediate form), was dipped in isopropyl alcohol (IPA) for 30 minutes at room temperature to replace the dichloromethane having impregnated the first intermediate with IPA. In this instance, the replacement was performed while rotating the bobbin so as to impregnate the fiber evenly with IPA. Then, the replacement was repeated under the same condition by replacing the IPA with a fresh one to effect totally 2 times of replacement.

Next, air-drying was performed at room temperature for 24 hours to remove IPA, and heating in an oven at a temperature of 120° C. was performed for 1 hour to remove IPA to obtain a second intermediate. The drying was performed while the diameter of the bobbin was allowed to decrease freely so as to relax the contraction stress applied to the fiber.

Next, the second intermediate form wound about the bobbin was immersed in an emulsified aqueous solution (surface tension=32.4 mN/m) obtained by dissolving polyglycerin fatty acid ester (“SY Glister ML-310” made by Sakamoto Yakuhin Kogyo Co., Ltd.; HLB=10.3), as a surfactant, at a concentration of 0.05 wt. % in pure water where, for 30 minutes at room temperature.

Then, while the bobbin was still immersed in the emulsified aqueous solution and rotated, the second intermediate form was longitudinally stretched at a ratio of 1.75 times by passing it on a first roller at a speed of 20.0 m/min., through a water bath at 60° C. and on a second roller at a speed of 35.0 m/min. Then, the intermediate form was caused to pass through a bath of warm water controlled at 90° C. to effect a first-stage relaxation of 8% and through a dry heating bath controlled at a spatial temperature of 140° C. to effect a second-stage relaxation of 1.5%, and then taken up to provide a polyvinylidene fluoride-based hollow-fiber porous membrane (a third form) according to the present invention. It took about 200 minutes until the stretching of the second intermediate form wound about the bobbin was completed.

The outline of Example 1 above and physical properties of the thus-obtained polyvinylidene fluoride-based hollow-fiber porous membrane, are summarized in Tables 1 and 2 appearing hereafter together with the results of Examples and Comparative Examples described below.

### Example 2

A polyvinylidene fluoride-based hollow-fiber porous membrane according to the present invention was obtained in the same manner as in Example 1 except for changing the cooling water bath temperature Tq after the melt-extrusion to 70° C.

### Example 3

A polyvinylidene fluoride-based hollow-fiber porous membrane according to the present invention was obtained in the same manner as in Example 1 except for using a polyvinylidene fluoride of Mw=4.9×10⁵ as PVDF-I to prepare PVDF-mixture A (crystallization temperature Tc=147.9° C.), and changing the cooling water bath temperature Tq after the melt-extrusion to 30° C.

### Comparative Example 1

A polyvinylidene fluoride-based hollow-fiber porous membrane was obtained essentially by the process of Example 1 of Patent document 11.

More specifically, a polyvinylidene fluoride-based hollow-fiber porous membrane was obtained in the same manner as in Example 1 except that a polyvinylidene fluoride of Mw=4.1×10⁵ was used as PVDF-I to prepare PVDF-mixture (Mixture A) (crystallization temperature Tc=150.4° C.); that as a plasticizer, a plasticizer mixture (Mixture B) obtained by mixing an adipic acid-based polyester plasticizer (polyester of adipic acid and 1,2-butanediol having a terminal capped with isononyl alcohol, “D623N” made by J-PLUS Co. Ltd.; number-average molecular weight=about 1800), a viscosity at 25° C. of 3000 mPa-s as measured by a cone-plate rotational viscometer according to JIS K7117-2) and a monomeric ester plasticizer (“DINA” made by J-PLUS Co. Ltd.) in a ratio of 88 wt. %/12 wt. % under stirring at room temperature, was used; that Mixture A and Mixture B were supplied at a ration of 27.9 wt. %/72.1 wt. %; the take-up speed was set to 5.0-m/min.; extraction rinsing with IPA after extraction with dichloromethane was omitted; and that the heat treatment after stretching was performed by passing through a warm water bath controlled at a temperature of 90° C. (namely, a first-stage relaxation rate=0%), and by passing through a dry heating vessel controlled at a spatial temperature of 80° C. (namely, a second-stage relaxation rate=0%).

### Comparative Example 2

A polyvinylidene fluoride-based hollow-fiber porous membrane was obtained essentially by the process of Example 7 of Patent document 11.

More specifically, a polyvinylidene fluoride-based hollow-fiber porous membrane was obtained in the same manner as in Comparative Example 1 except that a polyvinylidene fluoride of Mw=4.9×10⁵ was used as PVDF-I to prepare PVDF-mixture (Mixture A) (crystallization temperature Tc=149.3° C.); that Mixture A and Mixture B were supplied at a ration of 27.1 wt. %/72.9 wt. %; that the cooling water bath temperature Tq after the melt-extrusion was changed to 70° C.; that the take-up speed was changed to 3.3-m/min.; and that the heat treatment after stretching was performed to effect a first-stage relaxation of 8% in a water bath at 90° C. and a second-stage relaxation of 2% in a dry heating bath at 140° C.

### Comparative Example 3

A polyvinylidene fluoride-based hollow-fiber porous membrane was obtained essentially by the process of Example 8 of Patent document 11.

More specifically, a polyvinylidene fluoride-based hollow-fiber porous membrane was obtained in the same manner as in Comparative Example 2 except that the cooling water bath temperature Tq after the melt-extrusion was changed to 85° C.

### Comparative Example 4

A polyvinylidene fluoride-based hollow-fiber porous membrane was obtained essentially by the process of Patent document 7 (WO2005/099879A).

More specifically, a polyvinylidene fluoride-based hollow-fiber porous membrane was obtained in the same manner as in Comparative Example 1 except that a polyvinylidene fluoride of Mw=4.1×10⁵ was used as PVDF-I and mixed with PVDF-II in a ratio of 95 wt. %/5 wt. % to prepare PVDF-mixture A; that as a plasticizer was used a plasticize/solvent mixture B obtained by mixing an adipic acid-based polyester plasticizer (a polyester of adipic acid and 1,2-propylene glycol having a terminal capped with octyl alcohol (“PN150” made by ADEKA, Inc.; a number-average molecular weight=about 1000, viscosity=500 mPa-s) and N-methyl-pyrrolidone (NMP) at a ratio of 82.5 wt. %/17.5 wt. % at room temperature; that Mixture A and Mixture B were supplied at a ratio of 38.4 wt. %/61.6 wt. %; that the water cooling bath temperature was set to 40° C.; that the extraction rinse with IPA was omitted; that the stretching ratio was set to 1.85 times; that the heat treatment after stretching was performed to effect a first-stage relaxation of 8% in a water bath at 90° C. and a second-stage relaxation of 3% in air at 140° C.

### Comparative Example 5

A polyvinylidene fluoride-based hollow-fiber porous membrane was obtained essentially by a process of Patent document 9 (WO2008/117740A).

More specifically, a polyvinylidene fluoride of Mw=4.1×10⁵ was used as PVDF-I and mixed with PVDF-II in a ratio of 95 wt. %/5 wt. % to prepare PVDF-mixture A; and as a plasticizer was used a plasticize/solvent mixture B obtained by mixing an adipic acid-based polyester plasticizer (a polyester of adipic acid and 1,2-propylene glycol having a terminal capped with octyl alcohol (“PN150” made by ADEKA, Inc.; a number-average molecular weight=about 1000) and N-methyl-pyrrolidone (NMP) at a ratio of 68.6 wt. %/31.4 wt. %.

An equi-directional rotation and engagement-type twin-screw extruder (“BT-30”, made by Plastic Kogaku Kenkyusyo K.K.; screw diameter: 30 mm, L/D=48) was used, and Mixture A identical to the one used in Example 1 above was supplied from a powder supply port at a position of 80 mm from the upstream end of the cylinder and Mixture B heated to 160° C. was supplied from a liquid supply port at a position of 480 mm from the upstream end of the cylinder at a Mixture A/Mixture B ratio=30.8/69.2 (by weight), followed by kneading at a barrel temperature of 220° C. to extrude the melt-kneaded product through a nozzle (at 150° C.) having an annular slit of 6 mm in outer diameter and 4 mm in inner diameter into a hollow fiber-form extrudate. In this instance, air was injected into a hollow part of the fiber through an air supply port provided at a center of the nozzle so as to so as to adjust an inner diameter of the extrudate.

Thereafter, the melt-kneaded extrudate was cooled at a cooling water bath temperature of 15° C., subjected to extraction and stretching at a ratio of 1.1 times and then passed through a bath of warm water controlled at 90° C. and through a dry heating bath controlled at a spatial temperature of 140° C. to obtain a polyvinylidene fluoride-based hollow-fiber porous membrane.

### Comparative Example 6

A polyvinylidene fluoride-based hollow-fiber porous membrane was obtained essentially by the process of Patent document 10.

More specifically, a polyvinylidene fluoride of Mw=4.1×10⁵ was used as PVDF-I and mixed with PVDF-II in a ratio of 95 wt. %/5 wt. % to prepare PVDF-mixture A; and as a plasticizer was used a plasticize/solvent mixture B obtained by mixing an adipic acid-based polyester plasticizer (a polyester of adipic acid and 1,2-butanediol having a terminal capped with isononyl alcohol (“D620N” made by K.K. Jay Plus; a number-average molecular weight=about 800, a viscosity at 25° C. of 200 mPa-s as measured by a cone-plate rotational viscometer according to JIS K7117-2)) and N-methyl-pyrrolidone (NMP) at a ratio of 82.5 wt. %/17.5 wt. %.

An equi-directional rotation and engagement-type twin-screw extruder (“BT-30”, made by Plastic Kogaku Kenkyusyo K.K.; screw diameter: 30 mm, L/D=48) was used, and Mixture A was supplied from a powder supply port at a position of 80 mm from the upstream end of the cylinder and Mixture B heated to 160° C. was supplied from a liquid supply port at a position of 480 mm from the upstream end of the cylinder at a Mixture A/Mixture B ratio=38.4/61.6 (by weight), followed by kneading at a barrel temperature of 220° C. to extrude the melt-kneaded product through a nozzle (at 150° C.) having an annular slit of 7 mm in outer diameter and 5 mm in inner diameter into a hollow fiber-form extrudate. In this instance, air was injected into a hollow part of the fiber through an air supply port provided at a center of the nozzle so as to so as to adjust an inner diameter of the extrudate.

Thereafter, the melt-kneaded extrudate was cooled at a cooling water bath temperature of 70° C., subjected to extraction of Mixture B with dichloromethane, 1 hour of drying at 50° C., stretching at 2.4 times, relaxation of 11% in a warm water bath at 90° C. and relaxation of 1% in a dry heating bath controlled at a spatial temperature of 140° C. to obtain a polyvinylidene fluoride-based hollow-fiber porous membrane.

### Comparative Example 7)

Melt-extrusion was tried in the same manner as in Example 1 except for using a polyvinylidene fluoride of 4.1×10⁵ as PVDF-I. However, the extruded hollow-fiber film collapsed in the cooling water bath, thus failing to provide a membrane.

### Comparative Example 8)

Melt-extrusion was tried in the same manner as in Example 1 except for changing the cooling water bath temperature Tq after a melt-extrusion to 85° C. However, the extruded hollow-fiber film collapsed in the cooling water bath, thus failing to provide a membrane.

### Comparative Example 9

A polyvinylidene fluoride-based hollow-fiber porous membrane was prepared in the same manner as in Example 1 except that as the plasticizer was used a dibenzoate-type monomeric plasticizer (“PB-10” made by DIC Corporation, number average molecular weight=about 300, viscosity=81 mPa-s); that Mixture A and Mixture B were supplied at a ratio of 26.9 wt. %/73.1 wt. % and that the cooling water bath temperature Tq after the melt-extrusion was changed to 60° C.

The outlines of production conditions adopted in the above Examples and Comparative Examples and physical properties of the thus-obtained polyvinylidene fluoride-based hollow-fiber porous membranes, are inclusively shown in the following Tables 1 and 2. For convenience of comparison between Examples and Comparative Examples, a heading of “Mixture B” is used in these tables, even for a case wherein a plasticizer alone was blended with Mixture A (vinylidene fluoride resin mixture).

TABLE 1

| | Item | | Unit | Example 1 | Example 2 | Example 3 | Comp. Ex. 1 | Comp. Ex. 2 | Comp. Ex. 3 |
|---|---|---|---|---|---|---|---|---|---|
| Mixture A | Mw of PVDF(I) | | ×10⁵ | 6.6 | 6.6 | 4.9 | 4.1 | 4.9 | 4.9 |
| | Mwof PVDF(II) | | ×10⁵ | 9.7 | 9.7 | 9.7 | 9.7 | 9.7 | 9.7 |
| | Content of PVDF(I) | | Wt. % | 75 | 75 | 75 | 75 | 75 | 75 |
| | in Mixture A | | | | | | | | |
| | Content of PVDF(II) | | Wt. % | 25 | 25 | 25 | 25 | 25 | 25 |
| | in Mixture A | | | | | | | | |
| | Mw of Mixture A | | ×10⁵ | 7.4 | 7.4 | 6.1 | 5.4 | 6.1 | 6.1 |
| Mixture B | Polyester plasticizer | | | W-83 | W-83 | W-83 | D623N | D623N | D623N |
| | Polyester plasticizer M.W. | | | About 500 | About 500 | About 500 | About 1800 | About 1800 | About 1800 |
| | Monomeric ester plasticizer | | | | | | DINA | DINA | DINA |
| | Solvent | | | | | | | | |
| | Polyester plasticizer | | Wt. % | 100 | 100 | 100 | 88 | 88 | 88 |
| | in Mixture B | | | | | | | | |
| | Monomeric ester plasticizer | | Wt. % | | | | 12 | 12 | 12 |
| | in Mixture B | | | | | | | | |
| | Solvent in Mixture B | | Wt. % | | | | | | |
| | Viscosity of Mixture B | | mPa-s | 750 | 750 | 750 | 2600 | 2600 | 2600 |
| | (JIS K7117-2) | | | | | | | | |
| Extrusion | Mixture A | RA | Wt. % | 27.0 | 27.0 | 27.9 | 27.9 | 27.1 | 27.1 |
| ratio | Mixture B | RB | Wt. % | 73.0 | 73.0 | 72.1 | 72.1 | 72.9 | 72.9 |

| | | | | | | | | |
|---|---|---|---|---|---|---|---|---|
| Overall | PVDF | Wt. % | 27.0 | 27.0 | 27.9 | 27.9 | 27.1 | 27.1 |
| compo- | Polyester plasticizer | Wt. % | 73.0 | 73.0 | 72.1 | 63.4 | 64.2 | 64.2 |
| sition | Monomeric ester plasticizer | Wt. % | 0.0 | 0.0 | 0.0 | 8.7 | 8.7 | 8.7 |
| | Solvent | Wt. % | 0.0 | 0.0 | 0.0 | 0.0 | 0.0 | 0.0 |
| | Crystallization temp. Tc′ of | ° C. | 136.9 | 136.1 | 138.0 | 147.2 | 146.7 | 146.6 |
| | composition | | | | | | | |
| Produc- | Water bath temp. Tq | ° C. | 50 | 70 | 30 | 50 | 70 | 85 |
| tion | Tc′ − Tq | ° C. | 86.9 | 66.1 | 108 | 97.2 | 76.7 | 61.6 |
| con- | Take-up speed | m/min | 3.8 | 3.8 | 3.8 | 5 | 3.3 | 3.3 |
| ditions | ΔH′ of unextracted film | J/g | 54.2 | 57.4 | 60.8 | 61.3 | 54.6 | 57.5 |
| | Before-extraction heat | ° C. | | | | 120 | 120 | 120 |
| | treatment temperature | | | | | | | |
| | Before-extraction heat | min | | | | 60 | 60 | 60 |
| | treatment time | | | | | | | |
| | Extracting solvent | | DCM | DCM | DCM | DCM | DCM | DCM |
| | Rinse solvent | — | IPA | IPA | IPA | | | |
| | Unstretched fiber whole layer | % | 69.9 | 71.8 | 70.7 | 70.5 | 70.0 | 71.0 |
| | porosity AO | | | | | | | |
| | Stretching temperature | ° C. | 60 | 60 | 60 | 60 | 60 | 60 |
| | Stretching ratio | Times | 1.75 | 1.75 | 1.75 | 1.75 | 1.85 | 1.85 |
| | First-stage relaxation | | 90° C. wet | 90° C. wet | 90° C. wet | 90° C. wet | 90° C. wet | 90° C. wet |
| | Ratio | % | 8 | 8 | 8 | 0 | 8 | 8 |
| | Second-stage relaxation | | 140° C. dry | 140° C. dry | 140° C. dryt | 80° C. dry | 140° C. dryt | 140° C. dry |
| | Ratio | % | 1.5 | 1.5 | 1.5 | 0 | 2 | 2 |
| Physical | Outer diameter | mm | 1.55 | 1.57 | 1.57 | 1.52 | 1.52 | 1.55 |
| proper- | Inner diameter | mm | 1.03 | 1.06 | 1.06 | 0.98 | 1.02 | 1.00 |
| ties | Membrane thickness | mm | 0.25 | 0.25 | 0.25 | 0.27 | 0.26 | 0.28 |
| | Dense layer thickness | um | 12 | 26 | 34 | 45 | 55 | 60 |
| | Dense layer porosity A1 | % | 66 | 76 | 72 | 76 | 58 | 68 |
| | Whole layer porosity A2 | % | 80 | 80 | 80 | 81 | 80 | 82 |
| | Treated water-side surface | um | 0.13 | 0.15 | 0.13 | 0.15 | 0.17 | 0.23 |
| | pore size P1 | | | | | | | |
| | Permeated water side surface | um | 0.36 | 0.43 | 0.44 | 0.29 | 0.36 | 0.40 |
| | pore size P2 | | | | | | | |
| | A1/A2 | | 0.83 | 0.95 | 0.90 | 0.93 | 0.73 | 0.83 |
| | A1/P1 | | 507.7 | 506.7 | 566.9 | 524.1 | 341.2 | 293.1 |
| | P2/P1 | | 2.7 | 2.9 | 3.5 | 2.0 | 2.1 | 1.7 |
| | Average pore size P3 | um | 0.12 | 0.15 | 0.13 | 0.08 | 0.16 | 0.24 |
| | Maximum pore size P4 | um | 0.26 | 0.28 | 0.18 | 0.22 | 0.29 | 0.39 |
| | P1/P3 | | 1.10 | 1.00 | 0.99 | 1.81 | 1.06 | 0.99 |
| | Water permeability F | m/day | 24.5 | 40.4 | 33.8 | 21.2 | 39.5 | 61.1 |
| | 100 kPa, 25° C., L = 200 mm) | | | | | | | |
| | Normalized water permeability | m/day | 24.6 | 40.3 | 33.6 | 20.8 | 39.6 | 59.3 |
| | Q (A2 = 80%, 100 kPa, 25° C., | | | | | | | |
| | L = 200 mm) | | | | | | | |
| | Q/P1⁴ | ×10⁴ | 8.6 | 8.0 | 12.9 | 4.7 | 4.7 | 2.0 |
| | | m/day-um⁴ | | | | | | |
| | Tensile strength. | MPa | 7.50 | 6.6 | 6.00 | 7.6 | 7.8 | 6.6 |
| | Elongation | % | 81.1 | 50 | 103.7 | 196 | 139 | 95 |
| | Tc | ° C. | 148.3 | 148.4 | 148.9 | 150.4 | 149.3 | 148.9 |
| | Tc − Tc′ | ° C. | 11.4 | 12.3 | 10.9 | 3.2 | 2.6 | 2.3 |
| | Pore formation efficiency | | 1.0 | 1.0 | 1.0 | 1.0 | 1.0 | 1.0 |
| | A0/RB | | | | | | | |
| | Critical filtration flux | m/day | 0.9 | 0.9 | 0.9 | 0.8 | 0.9 | 0.8 |
| | Tm2 − Tc | ° C. | 24.7 | 24.6 | 24.1 | 22.6 | 23.7 | 24.1 |

TABLE 2

| | Item | | Unit | Comp. Ex. 4 | Comp. Ex. 5 | Comp. Ex. 6 | Comp. Ex. 7 | Comp. Ex. 8 | Comp. Ex. 9 |
|---|---|---|---|---|---|---|---|---|---|
| Mixture A | Mw of PVDF(I) | | ×10⁵ | 4.1 | 4.1 | 4.1 | 4.9 | 6.6 | 6.6 |
| | Mw of PVDF(II) | | ×10⁵ | 9.7 | 9.7 | 9.7 | 9.7 | 9.7 | 9.7 |
| | Content of PVDF(I) | | Wt. % | 95 | 75 | 95 | 75 | 75 | 75 |
| | in Mixture A | | | | | | | | |
| | Content of PVDF(II) | | Wt. % | 5 | 25 | 5 | 25 | 25 | 25 |
| | in Mixture A | | | | | | | | |
| | Mw of Mixture A | | ×10⁵ | 4.4 | 5.4 | 4.4 | 6.1 | 7.4 | 7.4 |
| Mixture B | Polyester plasticizer | | | PN-150 | PN-150 | D620N | W-83 | W-83 | |
| | Polyester plasticizer M.W. | | | About 1450 | About 1450 | About 800 | About 500 | About 500 | |
| | Monomeric ester plasticizer | | | | | | | | PB-10 |
| | Solvent | | | NMP | NMP | NMP | | | |
| | Polyester plasticizer | | Wt. % | 82.5 | 68.6 | 82.5 | 100 | 100 | |
| | in Mixture B | | | | | | | | |
| | Monomeric ester plasticizer | | Wt. % | | | | | | 100 |
| | in Mixture B | | | | | | | | |
| | Solvent in Mixture B | | Wt. % | 17.5 | 31.4 | 17.5 | | | |
| | Viscosity of Mixture B | | mPa-s | 400 | 350 | 160 | 750 | 750 | 81 |
| | (JIS K7117-2) | | | | | | | | |
| Extrusion | Mixture A | RA | Wt. % | 38.4 | 30.8 | 38.4 | 27.9 | 27.0 | 26.9 |
| ratio | Mixture B | RB | Wt. % | 61.6 | 69.2 | 61.6 | 72.1 | 73.0 | 73.1 |

| | | | | | | | | |
|---|---|---|---|---|---|---|---|---|
| Overall | PVDF | Wt. % | 38.4 | 30.8 | 38.4 | 27.9 | 27.0 | 26.9 |
| compo- | Polyester plasticizer | Wt. % | 50.8 | 47.5 | 50.8 | 72.1 | 73.0 | 0.0 |
| sition | Monomeric ester plasticizer | Wt. % | 0.0 | 0.0 | 0.0 | 0.0 | 0.0 | 73.1 |
| | Solvent | Wt. % | 10.8 | 21.7 | 10.8 | 0.0 | 0.0 | 0.0 |
| | Crystallization temp. Tc′ of | ° C. | 138.7 | 134.3 | 138.3 | 138.2 | 136.9 | 135.2 |
| | composition | | | | | | | |
| Produc- | Water bath temp. Tq | ° C. | 40 | 15 | 70 | 50 | 85 | 60 |
| tion | Tc′ − Tq | ° C. | 88.7 | 119.3 | 68.3 | 88.2 | 51.9 | 75.2 |
| con- | Take-up speed | m/min | 9.2 | 4.8 | 4.3 | | | 3.8 |
| ditions | ΔH′ of unextracted film | J/g | 49.6 | 46.0 | 46.6 | | | 60.3 |
| | Before-extraction heat | ° C. | | | 120 | | | |
| | treatment temperature | | | | | | | |
| | Before-extraction heat | min | | | 60 | | | |
| | treatment time | | | | | | | |
| | Extracting solvent | | DCM | DCM | DCM | | | DCM |
| | Rinse solvent | — | | | | | | IPA |
| | Unstretched fiber whole layer | % | 63.7 | 56.1 | 66.0 | | | 72.2 |
| | porosity AO | | | | | | | |
| | Stretching temperature | ° C. | 60 | 60 | 85 | | | 60 |
| | Stretching ratio | Times | 1.85 | 1.1 | 2.4 | | | 1.75 |
| | First-stage relaxation | | 90° C. wet | 90° C. wet | 90° C. wet | | | 90° C. wet |
| | Ratio | % | 8 | 0 | 11 | | | 8 |
| | Second-stage relaxation | | 140° C. dry | 140° C. dry | 140° C. dry | | | 140° C. dry |
| | Ratio | % | 3 | 0 | 1 | | | 1.5 |
| Physical | Outer diameter | mm | 1.37 | 1.37 | 1.37 | Fiber | Fiber | 1.57 |
| proper- | | | | | | collapsed | collapsed | |
| ties | Inner diameter | mm | 0.87 | 0.88 | 0.84 | | | 1.09 |
| | Membrane thickness | mm | 0.25 | 0.25 | 0.26 | | | 0.25 |
| | Dense layer thickness | um | 9 | <3 | Discontinuous | | | |
| | Dense layer porosity A1 | % | 41 | 38 | 53 | | | 63 |
| | Whole layer porosity A2 | % | 72 | 57 | 79 | | | 81 |
| | Treated water-side surface | um | 0.14 | 0.09 | 0.41 | | | 0.18 |
| | pore size P1 | | | | | | | |
| | Permeated water side surface | um | 0.47 | 0.29 | 1.07 | | | |
| | pore size P2 | | | | | | | |
| | A1/A2 | | 0.57 | 0.67 | 0.67 | | | 0.78 |
| | A1/P1 | | 292.9 | 422.2 | 129.3 | | | 360.0 |
| | P2/P1 | | 3.4 | 3.2 | 2.6 | | | |
| | Average pore size P3 | um | 0.10 | 0.05 | 0.19 | | | 0.08 |
| | Maximum pore size P4 | um | 0.20 | 0.09 | 0.36 | | | 0.17 |
| | P1/P3 | | 1.40 | 1.73 | 2.16 | | | 2.07 |
| | Water permeability F | m/day | 32.0 | 13.5 | 127.0 | | | 6.6 |
| | (100 kPa, 25° C., L = 200 mm) | | | | | | | |
| | Normalized water permeability | m/day | 35.8 | 18.9 | 129.3 | | | 6.6 |
| | Q (A2 = 80%, 100 kPa, 25° C., | | | | | | | |
| | L = 200 mm) | | | | | | | |
| | Q/P1⁴ | ×10⁴ | 9.3 | 28.9 | 0.5 | | | 0.7 |
| | | m/day-um⁴ | | | | | | |
| | Tensile strength. | MPa | 10.5 | 8.0 | 9.6 | | | |
| | Elongation | % | 93 | 21 | 11 | | | |
| | Tc | ° C. | 146.7 | 148.1 | 146.7 | | | 151.5 |
| | Tc − Tc′ | ° C. | 8.0 | 13.8 | 8.4 | | | 16.3 |
| | Pore formation efficiency | | 1.0 | 0.8 | 1.1 | | | 1.0 |
| | A0/RB | | | | | | | |
| | Critical filtration flux | m/day | 0.4 | 0.3 | 0.7 | | | |
| | Tm2 − Tc | ° C. | 26.3 | 24.9 | 26.3 | | | 21.5 |

### <<Partially Wet Stretching Method Examples>>

### Example A1

A matrix vinylidene fluoride resin (PVDF-I) (powder) having a weight-average molecular weight (Mw) of 4.9×10⁵ and a crystallinity modifier vinylidene fluoride resin (PVDF-II) (powder) having Mw=9.7×10⁵ were blended in proportions of 75 wt. % and 25 wt. %, respectively, by a Henschel mixer to obtain a PVDF mixture having Mw=6.1×10⁵.

As an organic liquid, an adipic acid-based polyester plasticizer (polyester of adipic acid and 1,2-butanediol having a terminal capped with isononyl alcohol, “D623N” made by J-PLUS Co. Ltd.; number-average molecular weight=about 1800), a viscosity at 25° C. of 3000 mPa-s as measured by a cone-plate rotational viscometer according to JIS K7117-2) and a monomeric ester plasticizer (“DINA” made by J-PLUS Co. Ltd.) were mixed in a ratio of 88 wt. %/12 wt. % under stirring at room temperature to obtain a plasticizer mixture.

An equi-directional rotation and engagement-type twin-screw extruder (“TEM-26SS”, made by Toshiba Kikai K.K.; screw diameter: 26 mm, L/D=60) was used, and Mixture A was supplied from a powder supply port to be melt-kneaded at a barrel temperature of 220° C., a plasticizer was supplied at a Mixture A/plasticizer ratio of 27.9 wt. %/72.1 wt. % from a liquid supply port downstream of the powder supply port to melt-kneaded at a barrel temperature of 220° C., and the melt-kneaded product was extruded through a nozzle (at 190° C.) having an annular slit of 6 mm in outer diameter and 4 mm in inner diameter into a hollow fiber-form extrudate. In this instance, air was injected into a hollow part of the fiber through an air supply port provided at a center of the nozzle so as to adjust an inner diameter of the extrudate.

The extruded mixture in a molten state was introduced into a cooling bath of water maintained at 45° C. and having a surface 280 mm distant from the nozzle (i.e., an air gap of 280 mm, Tq=45° C.) to be cooled and solidified (at a residence time in the cooling bath of about 6 sec.), pulled up at a take-up speed of 3.8 m/min. and wound up at a length of 500 m about a bobbin to obtain a first intermediate form with an outer diameter of 1.80 mm and an inner diameter of 1.20 mm.

Then, the first intermediate form was immersed in dichloromethane at room temperature for 30 min. to extract the plasticizer, while rotating the bobbin so as to impregnate the fiber evenly with dichloromethane. Then, the extraction was repeated under the same condition by replacing the dichloromethane with a fresh one to effect totally 3 times of extraction.

Next, first intermediate form containing dichloromethane, in a state before drying (i.e., a state where whitening is not visually observed in the first intermediate form), was dipped in isopropyl alcohol (IPA) for 30 minutes at room temperature to replace the dichloromethane having impregnated the first intermediate with IPA. In this instance, the replacement was performed while rotating the bobbin so as to impregnate the fiber evenly with IPA. Then, the replacement was repeated under the same condition by replacing the IPA with a fresh one to effect totally 2 times of replacement.

Next, air-drying was performed at room temperature for 24 hours to remove IPA, and heating in an oven at a temperature of 120° C. was performed for 1 hour to remove IPA to obtain a second intermediate. The drying was performed while the diameter of the bobbin was allowed to decrease freely so as to relax the contraction stress applied to the fiber.

Next, the second intermediate form wound about the bobbin was immersed in an emulsified aqueous solution (surface tension=32.4 mN/m) obtained by dissolving polyglycerin fatty acid ester (“SY Glister ML-310” made by Sakamoto Yakuhin Kogyo Co., Ltd.; HLB=10.3), as a surfactant, at a concentration of 0.05 wt. % in pure water where, for 30 minutes at room temperature.

Then, while the bobbin was still immersed in the emulsified aqueous solution and rotated, the second intermediate form was longitudinally stretched at a ratio of 1.75 times by passing it on a first roller at a speed of 20.0 m/min., through a water bath at 60° C. and on a second roller at a speed of 35.0 m/min. Then, the intermediate form was caused to pass through a bath of warm water controlled at 90° C. to effect a first-stage relaxation of 8% and through a dry heating bath controlled at a spatial temperature of 140° C. to effect a second-stage relaxation of 1.5%, and then taken up to provide a polyvinylidene fluoride-based hollow-fiber porous membrane in a wound-up form.

### Example A2

A polyvinylidene fluoride-based hollow-fiber porous membrane was obtained in the same manner as in Example A1 except for changing the cooling water bath temperature Tq after the melt-extrusion to 30° C. and changing the stretching ratio to 1.85 times.

### Example A3

A polyvinylidene fluoride-based hollow-fiber porous membrane was obtained in the same manner as in Example A1 except that as organic liquid, a polyester plasticizer (polyester of a dibasic acid and glycol having a terminal capped with adipic acid, “W-83” made by DIC Corporation; number-average molecular weight=about 500, a viscosity at 25° C. of 750 mPa-s as measured by a cone-plate rotational viscometer according to JIS K7117-2, a density=1.155 g/ml) was used; a supply ratio of vinylidene fluoride resin/plasticizer=26.9 wt. %/73.1 wt. % was used; the cooling water bath temperature Tq after the melt-extrusion was changed to 50° C.

### Example A4

A polyvinylidene fluoride-based hollow-fiber porous membrane was obtained in the same manner as in Example A1 except that as the organic liquid was used an alkylene glycol dibenzoate (“PB-10” made by DIC Corporation; which is a monomeric ester plasticizer having a number average molecular weight=about 300, a viscosity of 81 mPa-s at 25° C. as measured by JIS K7117-2 (cone-plate type rotational viscometer, a density=1.147 g/ml) was used; a supply ration of vinylidene-fluoride-resin/plasticizer=26.9 wt. %/73.1 wt. % was used; the cooling water bath temperature Tq after the melt-extrusion was changed to 60° C.; and the second stage relaxation rate was changed to 1.5%.

### Example A5

An unstretched vinylidene fluoride resin porous membrane was obtained according to a process substantially as disclosed in Patent document 4, and subjected to partial wetting and then stretching.

More specifically, hydrophobic silica (“Aerosil R-972” made by Nippon Aerosil K.K.; an average primary particle size of 16 nm, a specific surface area=110 m2/g) 14.8 vol. %, dioctyl phthalate (DOP) 48.5 vol. % and dibutyl phthalate (DBP) 4.4 vol. % were mixed with each other by a Henschel mixer, and to the mixture was added 32.3 wt. % of polyvinylidene fluoride (fine particles) having an weight-average molecular weight (Mw) of 2.4×10⁵, for further mixing by a Henschel mixer.

The mixture was supplied to and melt-kneaded by an equi-directional rotation and engagement-type twin-screw extruder (“TEM-26SS”, made by Toshiba Kikai K.K.; screw diameter: 26 mm, L/D=60) at a barrel temperature of 240° C., and the melt-kneaded product was extruded through a nozzle (at 240° C.) having an annular slit of 6 mm in outer diameter and 4 mm in inner diameter into a hollow fiber-form extrudate. In this instance, air was injected into a hollow part of the fiber through an air supply port provided at a center of the nozzle so as to adjust an inner diameter of the extrudate.

The extruded mixture in a molten state was introduced into a cooling bath of water maintained at 70° C. and having a surface 140 mm distant from the nozzle (i.e., an air gap of 140 mm, Tq=70° C.) to be cooled and solidified (at a residence time in the cooling bath of about 9 sec.), pulled up at a take-up speed of 2.5 m/min. obtain a first intermediate form with outer diameter of 2.87 mm and an inner diameter of 1.90 mm.

Then, the first intermediate form was immersed in dichloromethane at room temperature for 30 min. to extract the plasticizer. Then, the extraction was repeated under the same condition by replacing the dichloromethane with a fresh one to effect totally 4 times of extraction.

Next, the first intermediate form in the form of a porous hollow-fiber membrane was wetted by immersion in 50% ethanol aqueous solution for 30 minutes and then in pure water for 30 minutes. After the immersion, the porous hollow-fiber membrane was immersed in 20% sodium hydroxide aqueous solution at 70° C. for 1 hour to remove the hydrophobic silica, followed by washing with water to remove sodium hydroxide and drying in a vacuum dryer with a temperature at 30° C. for 24 hours, to obtain a second intermediate form. Incidentally, during a series of operations from extraction to drying, the both ends of hollow-fiber were not fixed so as to allow free contraction.

Next, the second intermediate form, after sealing both ends thereof, was immersed in an emulsified aqueous solution (surface tension=32.4 mN/m) obtained by dissolving polyglycerin fatty acid ester (“SY Glister ML-310” made by Sakamoto Yakuhin Kogyo Co., Ltd.; HLB=10.3), as a surfactant, at a concentration of 0.05 wt. % in pure water for 30 minutes at room temperature. Then, the second intermediate form was longitudinally stretched at a ratio of 1.75 times by hands and, fixation at both ends thereof, was heat-treated for 5 min. in a hot air oven at 140° C., to obtain a vinylidene fluoride resin porous hollow-fiber membrane.

### Comparative Example A1

A polyvinylidene fluoride-based hollow-fiber porous membrane was obtained in the same manner as in Example A1 except for omitting the partial wetting before the stretching.

### Comparative Example A2

A polyvinylidene fluoride-based hollow-fiber porous membrane was obtained in the same manner as in Example A2 except for omitting the partial wetting before the stretching.

### Comparative Example A3

A polyvinylidene fluoride-based hollow-fiber porous membrane was obtained in the same manner as in Example A2 except for using, as a partial wetting liquid, an aqueous solution (surface tension=28.9 mN/m) obtained by dissolving sodium alkyl ether sulfate ester at a concentration of 0.05 wt. % in pure water.

### Comparative Example A4

A polyvinylidene fluoride-based hollow-fiber porous membrane was obtained in the same manner as in Example A3 except for omitting the partial wetting before the stretching.

### Comparative Example A5

A polyvinylidene fluoride-based hollow-fiber porous membrane was obtained in the same manner as in Example A4 except for omitting the partial wetting before the stretching.

### Comparative Example A6

A polyvinylidene fluoride-based hollow-fiber porous membrane was obtained in the same manner as in Example A5 except for omitting the partial wetting before the stretching.

The outlines of production conditions adopted in the above Examples A and Comparative Examples A and physical properties of the thus-obtained polyvinylidene fluoride-based hollow-fiber porous membranes, are inclusively shown in the following Tables 3 and 4.

TABLE 3

| Item | | | Unit | Example A1 | Example A2 | Example A3 | Example A4 | Example A5 |
|---|---|---|---|---|---|---|---|---|
| Resin | Type of resin | | | PVDF | PVDF | PVDF | PVDF | PVDF |
| Pore-forming | Organic liquid *1 | | | D623N + | D623N + | W-83 | PB-10 | DOP + |
| agent | | | | DINA | DINA | | | DBP |
| | Viscosity | | mPa-s | 2600 | 2600 | 750 | 81 | 80 |
| | Specific gravity | | g/ml | 1.070 | 1.070 | 1.155 | 1.147 | 0.991 |
| | Inorganic particles | | | | | | | Silica |
| | Specific gravity | | g/ml | | | | | 2.2 |
| Extrusion | PVDF | RA | Wt. % | 27.9 | 27.9 | 26.9 | 26.9 | 40.4 |
| ratio | Organic liquid | RB | Wt. % | 72.1 | 72.1 | 73.1 | 73.1 | 36.8 |
| | Inorganic | RC | Wt. % | | | | | 22.9 |
| | particles | | | | | | | |
| Mixing ratio | PVDF | RA′ | Capacity % | 18.9 | 18.9 | 19.3 | 19.2 | 32.3 |
| by volume | Organic liquid | RB′ | Vol. % | 81.1 | 81.1 | 80.7 | 80.8 | 52.9 |
| | Inorganic | RC′ | Vol. % | | | | | 14.8 |
| | particles | | | | | | | |

| | | | | | | | |
|---|---|---|---|---|---|---|---|
| | [Organic liquid (+Inorganic | [—] | 4.30 | 4.30 | 4.19 | 4.22 | 2.10 |
| | particles)]/PVDF | | | | | | |
| | Ratio by volume | | | | | | |
| Fiber-forming | Water bath temp. Tq | ° C. | 45 | 30 | 50 | 60 | 70 |
| conditions | Take-up speed | m/min | 3.8 | 3.8 | 3.8 | 3.8 | 2.5 |
| Extraction | Extracting solvent *2 | | DCM | DCM | DCM | DCM | DCM |
| conditions | Rinse solvent *2 | | IPA | IPA | IPA | IPA | IPA |
| | Porosity of unstretched | % | 74 | 70 | 70 | 72 | 65 |
| | membrane | | | | | | |
| Stretching | Partial wetting | | Adopted | Adopted | Adopted | Adopted | Adopted |
| conditions | Surfactant *3 | | ML310 | ML310 | ML310 | ML310 | ML310 |
| | HLB of Surfactant | | 10.3 | 10.3 | 10.3 | 10.3 | 10.3 |
| | Surfactant concentration | Wt. % | 0.05 | 0.05 | 0.05 | 0.05 | 0.05 |
| | Surface tension of | mN/m | 32.4 | 32.4 | 32.4 | 32.4 | 32.4 |
| | partial wetting liquid | | | | | | |
| | Dipping time | min | 30-90 | 30-90 | 30-90 | 30-90 | 30-90 |
| | Wetting thickness | um | 15-50 | 15-50 | 15-50 | 15-50 | 15-50 |
| | Stretching temperature | ° C. | 60 | 60 | 60 | 60 | 25 |
| | Stretching ratio | Times | 1.75 | 1.85 | 1.75 | 1.75 | 1.85 |
| | First-stage relaxation | | 90° C. wet | 90° C. wet | 90° C. wet | 90° C. wet | 140° C. dry |
| | conditions | | | | | | |
| | Rate | % | 8 | 8 | 8 | 8 | 0 |
| | Second-stage relaxation | | 140° C. dry | 140° C. dry | 140° C. dry | 140° C. dry | |
| | conditions | | | | | | |
| | Rate | % | 3 | 3 | 3 | 1.5 | |
| Physical | Outer diameter | mm | 1.52 | 1.44 | 1.55 | 1.57 | 2.54 |
| properties | Inner diameter | mm | 1.02 | 0.99 | 1.03 | 1.09 | 1.65 |
| | Film thickness | mm | 0.27 | 0.23 | 0.25 | 0.25 | 0.43 |
| | Dense layer porosity | % | 68 | 72 | 66 | 63 | 48 |
| | A1 | | | | | | |
| | Whole layer porosity | % | 79 | 77 | 80 | 81 | 73 |
| | A2 | | | | | | |
| | Outer surface pore | um | 0.13 | 0.12 | 0.13 | 0.13 | 1.07 |
| | size P1 | | | | | | |
| | Inner surface pore | um | 0.23 | 0.29 | 0.36 | 0.29 | 1.71 |
| | size P2 | | | | | | |
| | A1/A2 | | 0.86 | 0.94 | 0.83 | 0.78 | 0.65 |
| | A1/P1 | | 523.1 | 605.0 | 507.7 | 484.6 | 45.1 |
| | P2/P1 | | 1.8 | 2.4 | 2.8 | 2.2 | 1.6 |
| | Average pore size P3 | um | 0.14 | 0.10 | 0.12 | 0.08 | 0.42 |
| | Maximum pore size P4 | um | 0.24 | 0.15 | 0.26 | 0.17 | 1.34 |
| | P1/P3 | | 0.93 | 1.23 | 1.10 | 1.54 | 2.56 |
| | Pure water permeation | m³/m²/day | 29.4 | 16.6 | 24.5 | 6.6 | 216.7 |
| | rate F (100 kPa, 25° | | | | | | |
| | C., L = 200 mm) | | | | | | |
| | Normalized water | m³/m²/day | 29.7 | 17.3 | 24.6 | 6.5 | 236.2 |
| | permeability Q (A2 = | | | | | | |
| | 80%, 100 kPa, 25° C., L = 200 | | | | | | |
| | Q/P1⁴ | | 10.4 | 8.6 | 8.6 | 2.3 | 0.02 |
| | Tensile strength. | MPa | 7.2 | 9.3 | 7.5 | 9.7 | 14.1 |
| | Tensile elongation | % | 163 | 176 | 81 | 139 | 26 |

*1: D623N: Polyester plasticizer (3000 mPa · s); DINA: Monomeric ester plasticizer (isononyl adipate);
W-83: Polyester plasticizer (750 mPa · S); PB10: Monomeric ester plasticizer (alkylene glycol dibenzoate);
DOP: Dioctyl phthalate; DBP: Dibutyl phthalate
*2: DCM: Dichloromethane; IPA: Isopropyl alcohol
*3: ML310: poly glycerine fatty acid ester (HLB = 10.3)

TABLE 4

| | | | | Comp. | Comp. | Comp. | Comp. | Comp. | Comp. |
|---|---|---|---|---|---|---|---|---|---|
| | Item | | Unit | Ex. A1 | Ex. A2 | Ex. A3 | Ex. A4 | Ex. A5 | Ex. A6 |
| Resin | Type of resin | | | PVDF | PVDF | PVDF | PVDF | PVDF | PVDF |
| Pore-forming | Organic liquid *1 | | | D623N + | D623N + | D623N + | W-83 | PB-10 | DOP + |
| agent | | | | DINA | DINA | DINA | | | DBP |
| | Viscosity | | mPa-s | 2600 | 2600 | 2600 | 750 | 81 | 80 |
| | Specific gravity | | g/ml | 1.070 | 1.070 | 1.070 | 1.155 | 1.147 | 0.991 |
| | Inorganic particles | | | | | | | | Silica |
| | Specific gravity | | g/ml | | | | | | 2.2 |
| Extrusion | PVDF | RA | Wt. % | 27.9 | 27.9 | 27.9 | 26.9 | 26.9 | 40.4 |
| ratio | Organic liquid | RB | Wt. % | 72.1 | 72.1 | 72.1 | 73.1 | 73.1 | 36.8 |
| | Inorganic particles | RC | Wt. % | | | | | | 22.9 |
| Mixing ratio | PVDF | RA′ | Capacity % | 18.9 | 18.9 | 18.9 | 19.3 | 19.2 | 32.3 |
| by volume | Organic liquid | RB′ | Vol. % | 81.1 | 81.1 | 81.1 | 80.7 | 80.8 | 52.9 |
| | Inorganic particles | RC′ | Vol. % | | | | | | 14.8 |

| | | | | | | | | |
|---|---|---|---|---|---|---|---|---|
| | [Organic liquid (+Inorganic | [—] | 4.30 | 4.30 | 4.30 | 4.19 | 4.22 | 2.10 |
| | particles)]/PVDF | | | | | | | |
| | Ratio by volume | | | | | | | |
| Fiber-forming | Water bath temp. Tq | ° C. | 45 | 30 | 30 | 50 | 60 | 70 |
| conditions | Take-up speed | m/min | 3.8 | 3.8 | 3.8 | 3.8 | 3.8 | 2.5 |
| Extraction | Extracting solvent *2 | | DCM | DCM | DCM | DCM | DCM | DCM |
| conditions | Rinse solvent *2 | | IPA | IPA | IPA | IPA | IPA | IPA |
| | Porosity of unstretched | % | 74 | 70 | 70 | 70 | 72 | 65 |
| | membrane | | | | | | | |
| Stretching | Partial wetting | | None | None | None | None | None | None |
| conditions | Surfactant *3 | | | | SAES | | | |
| | HLB of Surfactant | | | | | | | |
| | Surfactant concentration | Wt. % | | | 0.05 | | | |
| | Surface tension of | mN/m | | | 28.9 | | | |
| | partial wetting liquid | | | | | | | |
| | Dipping time | min | | | 30-90 | | | |
| | Wetting thickness | um | | | ≧150. | | | |
| | Stretching temperature | ° C. | 60 | 60 | 60 | 60 | 60 | 60 |
| | Stretching ratio | Times | 1.75 | 1.85 | 1.85 | 1.75 | 1.75 | 1.85 |
| | First-stage relaxation | | 90° C. wet | 90° C. wet | 90° C. wet | 90° C. wet | 90° C. wet | 140° C. dry |
| | conditions | | | | | | | |
| | Rate | % | 8 | 8 | 8 | 8 | 8 | 0 |
| | Second-stage relaxation | | 140° C. dry | 140° C. dry | 140° C. dry | 140° C. dry | Vol. % | |
| | conditions | | | | | | | |
| | Rate | % | 3 | 3 | 3 | 3 | 1.5 | |
| Physical | Outer diameter | mm | 1.51 | 1.49 | Continu- | 1.53 | 1.49 | 2.62 |
| properties | Inner diameter | mm | 1.02 | 1.01 | ation of | 1.03 | 1.04 | 1.74 |
| | Film thickness | mm | 0.24 | 0.26 | stretching | 0.25 | 0.24 | 0.45 |
| | Dense layer porosity | % | 39 | 41 | failed. *4 | 38 | 47 | 39 |
| | A1 | | | | | | | |
| | Whole layer porosity | % | 77 | 76 | | 79 | 77 | 72 |
| | A2 | | | | | | | |
| | Outer surface pore | um | 0.13 | 0.12 | | 0.13 | 0.14 | 1.26 |
| | size P1 | | | | | | | |
| | Inner surface pore | um | 0.23 | 0.30 | | 0.36 | 0.25 | 2.37 |
| | size P2 | | | | | | | |
| | A1/A2 | | 0.51 | 0.54 | | 0.48 | 0.61 | 0.54 |
| | A1/P1 | | 300.0 | 338.8 | | 292.3 | 348.1 | 31.0 |
| | P2/P1 | | 1.8 | 2.5 | | 2.8 | 1.9 | 1.9 |
| | Average pore size P3 | um | 0.14 | 0.10 | | 0.12 | 0.07 | 0.47 |
| | Maximum pore size P4 | um | 0.26 | 0.17 | | 0.26 | 0.16 | 1.29 |
| | P1/P3 | | 0.93 | 1.19 | | 1.10 | 1.80 | 2.66 |
| | Pure water permeation | m³/m²/day | 21.3 | 12.0 | | 18.0 | 6.0 | 191.0 |
| | rate F (100 kPa, 25° | | | | | | | |
| | C., L = 200 mm) | | | | | | | |
| | Normalized water | m³/m²/day | 22.1 | 12.6 | | 18.2 | 6.2 | 212.5 |
| | permeability Q (A2 = | | | | | | | |
| | 80%, 100 kPa, 25° C., L = 200 | | | | | | | |
| | mm) | | | | | | | |
| | Q/P1⁴ | | 7.7 | 5.9 | | 6.4 | 1.9 | 0.01 |
| | Tensile strength. | MPa | 7.2 | 9.2 | | 7.6 | 11.1 | 13.7 |
| | Tensile elongation | % | 167 | 191 | | 90 | 145 | 19 |

*1: D623N: Polyester plasticizer (3000 mPa · s); DINA: Monomeric ester plasticizer (isononyl adipate);
W-83: Polyester plasticizer (750 mPa · S); PB10: Monomeric ester plasticizer (alkylene glycol dibenzoate);
DOP: Dioctyl phthalate; DBP: Dibutyl phthalate
*2: DCM: Dichloromethane; IPA: Isopropyl alcohol
*3: ML310: poly glycerine fatty acid ester (HLB = 10.3); SAES: Sodium alkyl ether sulfate
*4: During second-stage relaxation, the fiber slackened so thart the stretching could not be continued.

[Evaluation]

As is understood from a comparison of the results of Examples A and Comparative Examples A shown in Tables 3-4 above, according to the partially wet stretching method wherein a once-formed porous resin membrane is subjected to stretching after selective partial wetting of a proximity to the surface, a lowering in porosity of the surface proximity during the stretching is prevented to provide a porous resin membrane product which retains a high porosity A1 of a dense layer proximity to the surface governing the separation performance and a high permeability through a whole membrane. This effect is especially noticeably recognized in the cases where the smaller pore-side surface pore size P1 governing the separation performance is as small as 0.2 um or smaller (as in Examples A1-A4, Comparative Examples A1-A5), compared with the cases where the smaller pore-side surface pore size P1 is as relatively large as about 1 um (as in Example A5, Comparative Example A6).

<<Extraction rinsing method Examples>>

### Example B1

A matrix vinylidene fluoride resin (PVDF-I) (powder) having a weight-average molecular weight (Mw) of 4.9×10⁵ and a crystallinity modifier vinylidene fluoride resin (PVDF-II) (powder) having Mw=9.7×10⁵ were blended in proportions of 75 wt. % and 25 wt. %, respectively, by a Henschel mixer to obtain a PVDF mixture having Mw=6.1×10⁵.

As an organic liquid, a polyester plasticizer (polyester of a dibasic acid and glycol having a terminal capped with a monobasic acid, “W-4010” made by DIC Corporation; number-average molecular weight=about 4000, a viscosity at 25° C. of 18000 mPa-s as measured by a cone-plate rotational viscometer according to JIS K7117-2, a density=1.113 g/ml) and a monomeric ester plasticizer (“DINA” made by J-PLUS Co. Ltd., a viscosity at 25° C. of 16 mPa-s as measured by a cone-plate rotational viscometer according to JIS K7117-2, a density=0.923 g/ml) were mixed in a ratio of 80 wt. %/20 wt. % under stirring at room temperature to obtain a plasticizer mixture.

An equi-directional rotation and engagement-type twin-screw extruder (“TEM-26SS”, made by Toshiba Kikai K.K.; screw diameter: 26 mm, L/D=60) was used, and Mixture A was supplied from a powder supply port to be melt-kneaded at a barrel temperature of 220° C., Mixture B was supplied at a Mixture A/Mixture B ratio of 27.9 wt. %/72.1 wt. % from a liquid supply port downstream of the powder supply port to melt-kneaded at a barrel temperature of 220° C., and the melt-kneaded product was extruded through a nozzle (at 190° C.) having an annular slit of 6 mm in outer diameter and 4 mm in inner diameter into a hollow fiber-form extrudate. In this instance, air was injected into a hollow part of the fiber through an air supply port provided at a center of the nozzle so as to adjust an inner diameter of the extrudate.

The extruded mixture in a molten state was introduced into a cooling bath of water maintained at 12° C. and having a surface 280 mm distant from the nozzle (i.e., an air gap of 280 mm, Tq=12° C.) to be cooled and solidified (at a residence time in the cooling bath of about 6 sec.), pulled up at a take-up speed of 3.8 m/min. and wound up at a length of 500 m about a bobbin with a core diameter of 220 mm to obtain a first intermediate form (a hollow-fiber porous membrane of vinylidene fluoride resin containing an organic liquid) with an outer diameter of 1.80 mm and an inner diameter of 1.20 mm.

Then, the first intermediate form was cut into a length of 300 mm and immersed in dichloromethane at room temperature for 30 min. with both ends thereof unfixed to extract the organic liquid, while stirring the dichloromethane so as to impregnate the fiber evenly with dichloromethane. Then, the extraction was repeated under the same condition by replacing the dichloromethane with a fresh one to effect totally 3 times of extraction.

Next, the first intermediate form containing dichloromethane, in a state before drying (i.e., a state where whitening was not visually observed in the first intermediate form) with both ends thereof unfixed, was dipped in ethanol (showing a swelling power of 0.5% for the starting vinylidene fluoride resin) for 30 minutes at room temperature to replace the dichloromethane having impregnated the first intermediate with ethanol. In this instance, the replacement was performed while stirring the ethanol so as to impregnate the fiber evenly with ethanol. Then, the replacement was repeated under the same condition by replacing the ethanol with a fresh one to effect totally 2 times of replacement.

Next, air-drying was performed at room temperature for 24 hours to remove ethanol while unfixing both ends of the hollow-fiber, and heating in an oven at a temperature of 120° C. was performed for 1 hour to remove ethanol to obtain a hollow-fiber porous membrane of vinylidene fluoride resin.

### Example B2

A hollow-fiber porous membrane of vinylidene fluoride resin was obtained in the same manner as in Example B1 except for using isopropyl alcohol (showing a swelling power of 0.2% for the starting vinylidene fluoride resin) as the rinsing liquid.

### Example B3

A hollow-fiber porous membrane of vinylidene fluoride resin was obtained in the same manner as in Example B1 except for using hexane (showing a swelling power of 0.0% for the starting vinylidene fluoride resin) as the rinsing liquid.

### Example B4

A hollow-fiber porous membrane of vinylidene fluoride resin was obtained in the same manner as in Example B1 except that after the replacement with ethanol as the rinsing liquid, the hollow-fiber porous membrane containing ethanol, substantially without being dried, was subjected to second rinsing with water (showing a swelling power of 0.0% for the starting vinylidene fluoride resin) as the rinsing liquid.

### Comparative Example B1

A hollow-fiber porous membrane of vinylidene fluoride resin was obtained in the same manner as in Example B1 except for using dichloromethane (showing a swelling power of 5.7% for the starting vinylidene fluoride resin) as the rinsing liquid.

### Comparative Example B2

A hollow-fiber porous membrane of vinylidene fluoride resin was obtained in the same manner as in Example B1 except for using methanol (showing a swelling power of 1.8% for the starting vinylidene fluoride resin) as the rinsing liquid.

### Comparative Example B3

A hollow-fiber porous membrane of vinylidene fluoride resin was obtained in the same manner as in Example B1 except for using acetone (showing a swelling power of 5.0% for the starting vinylidene fluoride resin) as the rinsing liquid.

### Comparative Example B4

A hollow-fiber porous membrane of vinylidene fluoride resin was obtained in the same manner as in Example B1 except for using a heptafluorocyclopentane-based solvent (“ZEORORA HTA” made by Zeon Corporation; showing a swelling power of 3.4% for the starting vinylidene fluoride resin) as the rinsing liquid.

### Example B5

A hollow-fiber porous membrane of vinylidene fluoride resin was obtained in the same manner as in Example B2 except that as the organic liquid was used a plasticizer mixture obtained by mixing a polyester plasticizer (polyester of adipic acid and 1,2-butanediol having a terminal capped with isononyl alcohol, “D623N” made by J-PLUS Co. Ltd.; number-average molecular weight=about 1800, a viscosity at 25° C. of 3000 mPa-s as measured by a cone-plate rotational viscometer according to JIS K7117-2, a density=1.090 g/ml) and a monomeric ester plasticizer (“DINA” made by J-PLUS Co. Ltd.) in a ratio of 88 wt. %/12 wt. % under stirring at room temperature; and that the cooling water bath temperature Tq after the melt-extrusion was changed to 45° C.

### Comparative Example B5

A hollow-fiber porous membrane of vinylidene fluoride resin was obtained in the same manner as in Example B5 except for using dichloromethane (showing a swelling power of 5.7% for the starting vinylidene fluoride resin) as the rinsing liquid.

### Example B6

A hollow-fiber porous membrane of vinylidene fluoride resin was obtained in the same manner as in Example B2 except that as the vinylidene fluoride resin was used a PVDF mixture having Mw=7.4×10⁵ obtained by blending a matrix vinylidene fluoride resin (PVDF-I) (powder) having a weight-average molecular weight (Mw) of 6.6×10⁵ and a crystallinity modifier vinylidene fluoride resin (PVDF-II) (powder) having Mw=9.7×10⁵ in proportions of 75 wt. % and 25 wt. %, respectively, by a Henschel mixer; that as the plasticizer was used a polyester plasticizer (polyester of a dibasic acid and glycol having a terminal capped with adipic acid, “W-83” made by DIC Corporation; number-average molecular weight=about 500, a viscosity at 25° C. of 750 mPa-s as measured by a cone-plate rotational viscometer according to JIS K7117-2, a density=1.155 g/ml); that the vinylidene fluoride resin and the plasticizer was supplied at a ratio of 26.9 wt. %/73.1 wt. %; and that the cooling water bath temperature Tq after the melt-extrusion was changed to 50° C.

### Comparative Example B6

A hollow-fiber porous membrane of vinylidene fluoride resin was obtained in the same manner as in Example B6 except for using dichloromethane (showing a swelling power of 5.7% for the starting vinylidene fluoride resin) as the rinsing liquid.

### Example B7

A hollow-fiber porous membrane of vinylidene fluoride resin was obtained in the same manner as in Example B2 except that as the organic liquid was used an alkylene glycol dibenzoate (“PB-10” made by DIC Corporation; which is a monomeric ester plasticizer having a number average molecular weight=about 300, a viscosity of 81 mPa-s at 25° C. as measured by JIS K7117-2 (cone-plate type rotational viscometer, a density=1.147 g/ml) was used; and that the cooling water bath temperature Tq after the melt-extrusion was changed to 60° C.

### Comparative Example B7

A hollow-fiber porous membrane of vinylidene fluoride resin was obtained in the same manner as in Example B7 except for using dichloromethane (showing a swelling power of 5.7% for the starting vinylidene fluoride resin) as the rinsing liquid.

The outlines of the above-described Examples B-1 to B-7 and Comparative Examples B-1 to B-7 and physical properties of the thus-obtained hollow-fiber porous membranes of vinylidene fluoride resin, are inclusively shown Table 5 hereafter.

In the above-mentioned Examples B and Comparative Examples B, a discrete single fiber of first intermediate form (vinylidene fluoride hollow-fiber membrane containing an organic liquid after phase separation) was subjected to extraction (and subsequent rinsing). On the other hand, in the following Examples B and Comparative Examples B, a first intermediate form in a state of being wound about a bobbin was subjected to extraction (and subsequent rinsing) to evaluate the easiness of extraction on the bobbin accompanied with reduction in size contraction according to the process of the present invention and physical properties of the resultant membrane after subsequent stretching.

### Example B8

A first intermediate form (500 m in length) obtained in a form of being wound about a bobbin (having a core diameter: 220 mm) in Example B5, as it was wound about the bobbin, was immersed in dichloromethane to extract the plasticizer. The extraction was performed while rotating the bobbin so as to impregnate the fiber evenly with dichloromethane. Then, the extraction was repeated under the same condition by replacing the dichloromethane with a fresh one to effect totally 3 times of extraction.

Next, first intermediate form containing dichloromethane, in a state before drying (i.e., a state where whitening is not visually observed in the first intermediate form), was dipped in isopropyl alcohol (IPA) for 30 minutes at room temperature to replace the dichloromethane having impregnated the first intermediate with IPA. In this instance, the replacement was performed while rotating the bobbin so as to impregnate the fiber evenly with IPA. Then, the replacement was repeated under the same condition by replacing the IPA with a fresh one to effect totally 2 times of replacement.

Next, air-drying was performed at room temperature for 24 hours to remove IPA, and heating in an oven at a temperature of 120° C. was performed for 1 hour to remove IPA to obtain a second intermediate. The drying was performed while the diameter of the bobbin was allowed to decrease freely so as to relax the contraction stress applied to the fiber.

Next, the second intermediate form wound about the bobbin was immersed in an emulsified aqueous solution (surface tension=32.4 mN/m) obtained by dissolving polyglycerin fatty acid ester (“SY Glister ML-310” made by Sakamoto Yakuhin Kogyo Co., Ltd.; HLB=10.3), as a surfactant, at a concentration of 0.05 wt. % in pure water where, for 30 minutes at room temperature.

Then, while the bobbin was still immersed in the emulsified aqueous solution and rotated, the second intermediate form was longitudinally stretched at a ratio of 1.75 times by passing it on a first roller at a speed of 20.0 m/min., through a water bath at 60° C. and on a second roller at a speed of 35.0 m/min. Then, the intermediate form was caused to pass through a bath of warm water controlled at 90° C. to effect a first-stage relaxation of 8% and through a dry heating bath controlled at a spatial temperature of 140° C. to effect a second-stage relaxation of 1.5%, and then taken up to provide a hollow-fiber porous membrane of vinylidene fluoride resin in a wound-up form.

### Example B9

A hollow-fiber porous membrane of vinylidene fluoride resin was obtained in the same manner as in Example B8 except for using a first intermediate form (500 m in length) obtained in a form of being wound about a bobbin (having a core diameter: 220 mm) in Example B5.

### Example B10

A hollow-fiber porous membrane of vinylidene fluoride resin was obtained in the same manner as in Example B8 except for using a first intermediate form (500 m in length) obtained in a form of being wound about a bobbin (having a core diameter: 220 mm) in Example B7.

### Comparative Example B8

Extraction on a bobbin, and subsequent drying and heat treatment were conducted in the same manner as in Example B8 except for using dichloromethane (showing a swelling power of 5.7% for the starting vinylidene fluoride resin) as the rinsing liquid. However, a mutual intrusion due to volumetric contraction and a curl of the hollow-fiber were caused, so that it could not be applied to subsequent stretching.

### Comparative Example B9

Extraction on a bobbin, and subsequent drying and heat treatment were conducted in the same manner as in Example B9 except for using dichloromethane (showing a swelling power of 5.7% for the starting vinylidene fluoride resin) as the rinsing liquid. However, a mutual intrusion due to volumetric contraction and a curl of the hollow-fiber were caused, so that it could not be applied to subsequent stretching.

### Comparative Example B10

Extraction on a bobbin, and subsequent drying and heat treatment were conducted in the same manner as in Example B10 except for using dichloromethane (showing a swelling power of 5.7% for the starting vinylidene fluoride resin) as the rinsing liquid. However, a mutual intrusion due to volumetric contraction and a curl of the hollow-fiber were caused, so that it could not be applied to subsequent stretching.

### Example B11

A first intermediate form (500 m in length) obtained in a form of being wound about a bobbin (having a core diameter: 220 mm) in Example B6 was taken out form the bobbin was longitudinally stretched at a ratio of 2.5 times by passing it on a first roller at a speed of 20.0 m/min., through a water bath at 60° C. and on a second roller at a speed of 50 m/min. Then, the intermediate form was caused to pass through a bath of warm water controlled at 90° C. to effect a first-stage relaxation of 8% and through a dry heating bath controlled at a spatial temperature of 140° C. to effect a second-stage relaxation of 1.5%, and then wound about a bobbin to provide a stretched hollow-fiber in a wound-up form.

Then, the stretched hollow-fiber, as it was wound about the bobbin, was immersed in dichloromethane to extract the organic liquid. The extraction was performed while rotating the bobbin so as to impregnate the fiber evenly with dichloromethane. Then, the extraction was repeated under the same condition by replacing the dichloromethane with a fresh one to effect totally 3 times of extraction.

Next, the stretched fiber containing dichloromethane, in a state before drying (i.e., a state where whitening was not visually observed in the first intermediate form), was dipped in isopropyl alcohol (IPA) as a rinsing liquid for 30 minutes at room temperature to replace the dichloromethane having impregnated the first stretched fiber with IPA. In this instance, the replacement was performed while rotating the bobbin so as to impregnate the fiber evenly with IPA. Then, the replacement was repeated under the same condition by replacing the IPA with a fresh one to effect totally 2 times of replacement.

Next, air-drying was performed at room temperature for 24 hours to remove IPA, and heating in an oven at a temperature of 120° C. was performed for 1 hour to remove IPA to obtain a hollow-fiber porous membrane of vinylidene fluoride resin. The drying and heat treatment were performed while the diameter of the bobbin was allowed to decrease freely so as to relax the contraction stress applied to the fiber.

### Comparative Example B11

Extraction on a bobbin, and subsequent drying and heat treatment, were conducted in the same manner as in Example B11 except for using dichloromethane (showing a swelling power of 5.7% for the starting vinylidene fluoride resin) as the rinsing liquid. However, a mutual intrusion due to volumetric contraction and a curl of the hollow-fiber were caused, so that it could not be applied to subsequent stretching.

### Example B12

A hollow-fiber porous membrane of vinylidene fluoride resin was obtained in the same manner as in Example B8 except that a first intermediate form (500 m in length) obtained in a form of being wound about a bobbin (having a core diameter: 220 mm) in Example B1 was used; and that ethanol was used as a rinsing liquid to effect the replacement of dichloromethane, and then the hollow-fiber porous membrane containing ethanol without substantial drying was subjected to replacement with water (showing a swelling power of 0.0% for the starting vinylidene fluoride resin) as a second rinsing liquid.

### Comparative Example B12

Extraction on a bobbin, and subsequent drying and heat treatment were conducted in the same manner as in Example B12 except for using dichloromethane (showing a swelling power of 5.7% for the starting vinylidene fluoride resin) as the rinsing liquid. However, a mutual intrusion due to volumetric contraction and a curl of the hollow-fiber were caused, so that it could not be applied to subsequent stretching.

The outlines of the above-described Examples B-8 to B-12 and Comparative Examples B-8 to B-12 and results of evaluation of the thus-obtained hollow-fiber porous membranes of vinylidene fluoride resin, are inclusively shown Table 6 hereafter.

TABLE 5

| | | | | | | | Comp. | Comp. | Comp. |
|---|---|---|---|---|---|---|---|---|---|
| Item | | Unit | Ex. B1 | Ex. B2 | Ex. B3 | Ex. B4 | Ex. B1 | Ex. B2 | Ex. B3 |
| Organic | Species *1 | | W-4010 + | W-4010 + | W-4010 + | W-4010 + | W-4010 + | W-4010 + | W-4010 + |
| liquid | | | DINA | DINA | DINA | DINA | DINA | DINA | DINA |
| | Viscosity | mPa-s | 14400 | 14400 | 14400 | 14400 | 14400 | 14400 | 14400 |
| | Specific gravity | g/ml | 1.075 | 1.075 | 1.075 | 1.075 | 1.075 | 1.075 | 1.075 |
| Extrusion | PVDF | Wt. % | 27.9 | 27.9 | 27.9 | 27.9 | 27.9 | 27.9 | 27.9 |
| ratio | Organic liquid | Wt. % | 72.1 | 72.1 | 72.1 | 72.1 | 72.1 | 72.1 | 72.1 |
| Mixing ratio | PVDF | Vol. % | 18.9 | 18.9 | 18.9 | 18.9 | 18.9 | 18.9 | 18.9 |
| by volume | | | | | | | | | |
| | Organic liquid RL | Vol. % | 81.1 | 81.1 | 81.1 | 81.1 | 81.1 | 81.1 | 81.1 |
| | Organic liquid/PVDF | Vol. % | 428 | 428 | 428 | 428 | 428 | 428 | 428 |
| Water bath temp. Tq | | ° C. | 12 | 12 | 12 | 12 | 12 | 12 | 12 |
| [symbol] H′ of extruded film | | J/g | 55.2 | 55.2 | 55.2 | 55.2 | 55.2 | 55.2 | 55.2 |
| Before-extraction heat treatment | | | None | None | None | None | None | None | None |
| Extracting solvent *2 | | | DCM | DCM | DCM | DCM | DCM | DCM | DCM |
| Rinse agent | Species *2 | | Ethanol | IPA | Hexane | Water | DCM | Methanol | Acetone |
| | Vapor pressure | kPa/20° C. | 5.3 | 4.1 | 16.1 | 2.3 | 47.4 | 13.0 | 24.7 |
| | Boiling point | ° C. | 78.3 | 83 | 68.7 | 100 | 40.2 | 64.7 | 56.1 |
| | Surface tension | mN/m | 22.4 | 22.6 | 18.4 | 73 | 28.1 | — | 23.3 |
| | SP value | (MPa)\hat{ }½ | 13.0 | 12.0 | 7.2 | 23.4 | 9.7 | 14.5 | 9.8 |
| | Swelling power to PVDF | Wt. % | 0.5 | 0.2 | 0.0 | 0.0 | 5.7 | 1.8 | — |
| Rate of size | Longitudinal shrinkability | % | 15.7 | 12.3 | 5.5 | 8.8 | 40.0 | 32.5 | 38.7 |
| contraction | Outer diameter shrinkability | % | 11.7 | 10.4 | 6.8 | 9.0 | 39.3 | 32.7 | 37.9 |
| | Inner diameter shrinkability | % | 9.9 | 7.2 | 3.7 | 4.5 | 39.0 | 29.3 | 36.6 |
| | Thickness compressibility | % | 15.0 | 12.5 | 8.5 | 10.0 | 42.4 | 37.2 | 42.6 |

| | | | | | | | | |
|---|---|---|---|---|---|---|---|---|
| Whole layer porosity A2 | % | 69 | 70 | 74 | 71 | 5 | 23 | 11 |
| Pore formation efficiency A2/RL | | 0.85 | 0.86 | 0.91 | 0.88 | 0.06 | 0.28 | 0.14 |

| | | | Comp. | | Comp. | | Comp. | | Comp. |
|---|---|---|---|---|---|---|---|---|---|
| Item | | Unit | Ex. B4 | Ex. B5 | Ex. B5 | Ex. B6 | Ex. B6 | Ex. B7 | Ex. B7 |
| Organic | Species *1 | | W-4010 + | D623N + | D623N + | W-83 | W-83 | PB-10 | PB-10 |
| liquid | | | DINA | DINA | DINA | | | | |
| | Viscosity | mPa-s | 14400 | 2600 | 2600 | 750 | 750 | 81 | 81 |
| | Specific gravity | g/ml | 1.075 | 1.070 | 1.070 | 1.155 | 1.155 | 1.147 | 1.147 |
| Extrusion | PVDF | Wt. % | 27.9 | 27.9 | 27.9 | 26.9 | 26.9 | 26.9 | 26.9 |
| ratio | Organic liquid | Wt. % | 72.1 | 73.0 | 73.0 | 73.1 | 73.1 | 73.1 | 73.1 |
| Mixing ratio | PVDF | Vol. % | 18.9 | 18.7 | 18.7 | 19.3 | 19.3 | 19.2 | 19.2 |
| by volume | | | | | | | | | |
| | Organic liquid RL | Vol. % | 81.1 | 81.3 | 81.3 | 80.7 | 80.7 | 80.8 | 80.8 |
| | Organic liquid/PVDF | Vol. % | 428 | 435 | 435 | 419 | 419 | 422 | 422 |
| Water bath temp. Tq | | ° C. | 12 | 45 | 45 | 50 | 50 | 60 | 60 |
| [symbol] H′ of extruded film | | J/g | 55.2 | 56.5 | 56.5 | 54.2 | 54.2 | 60.3 | 60.3 |
| Before-extraction heat treatment | | | None | None | None | None | None | None | None |
| Extracting solvent *2 | | | DCM | DCM | DCM | DCM | DCM | DCM | DCM |
| Rinse agent | Species *2 | | ZEORORA | IPA | DCM | IPA | DCM | IPA | DCM |
| | Vapor pressure | kPa/20° C. | 9.2 | 4.1 | 47.4 | 4.1 | 47.4 | 4.1 | 47.4 |
| | Boiling point | ° C. | 82 | 83 | 40.2 | 83 | 40.2 | 83 | 40.2 |
| | Surface tension | mN/m | 20.3 | 22.6 | 28.1 | 22.6 | 28.1 | 22.6 | 28.1 |
| | SP value | (MPa)\hat{ }½ | 8.3 | 12.0 | 9.7 | 12.0 | 9.7 | 12.0 | 9.7 |
| | Swelling power to PVDF | Wt. % | — | 0.2 | 5.7 | 0.2 | 5.7 | 0.2 | 5.7 |
| Rate of size | Longitudinal shrinkability | % | 37.5 | 7.0 | 16.7 | 10.3 | 14.7 | 10.0 | 15.2 |
| contraction | Outer diameter shrinkability | % | 35.8 | 6.2 | 14.0 | 6.8 | 8.2 | 9.2 | 14.9 |
| | Inner diameter shrinkability | % | 33.0 | 1.4 | 9.6 | 5.5 | 6.7 | 7.2 | 11.9 |
| | Thickness compressibility | % | 41.9 | 12.7 | 20.8 | 4.4 | 9.7 | 10.8 | 14.6 |

| | | | | | | | | |
|---|---|---|---|---|---|---|---|---|
| Whole layer porosity A2 | % | 11 | 74 | 67 | 70 | 68 | 72 | 66 |
| Pore formation efficiency A2/RL | | 0.13 | 0.91 | 0.82 | 0.87 | 0.84 | 0.89 | 0.82 |

*1: W-4010: polyester plasticizer (18000 mPa · s); DINA: Monomeric ester plasticizer (isononyl adipate); D623N: Polyester plasticizer (3000 mPa · s);
W-83: Polyester Plasticizer (750 MPa · S); PB-10: Monomeric Ester Plasticizer (Alkylene Glycol Dibenzoate)
*2: DCM: dichloromethane; ZEORORA: Heptafluoro-cyclopentane-based solvent; IPA: Isopropyl alcohol

TABLE 6

| | | | | | | Comp. | Comp. | Comp. |
|---|---|---|---|---|---|---|---|---|
| Item | | Unit | Ex. B8 | Ex. B9 | Ex. B10 | Ex. B8 | Ex. B9 | Ex. B10 |
| Conditions for producing first intermediate form | | | Ex. B5 | Ex. B6 | Ex. B7 | Ex. B5 | Ex. B6 | Ex. B7 |
| Extraction | Extracting solvent *1 | | DCM | DCM | DCM | DCM | DCM | DCM |
| on a bobbin | Rinsing agent *1 | | IPA | IPA | IPA | DCM | DCM | DCM |
| Stretching | Before or after Extarction | | After | After | After | After | After | After |
| | Stretching temperature | ° C. | 60 | 60 | 60 | Stretch- | Stretch- | Stretch- |
| | Stretching ratio | Times | 1.75 | 1.75 | 1.75 | ing | ing | ing |
| Physical | Outer diameter | mm | 1.52 | 1.55 | 1.57 | failure | failure | failure |
| propertiese | Inner diameter | mm | 1.02 | 1.03 | 1.09 | *3 | *3 | *3 |
| of stretched fiber | Membrane thickness | mm | 0.27 | 0.25 | 0.25 | | | |
| | Dense layer porosity A1 | % | 68 | 66 | 63 | | | |
| | Whole layer porosity A2 | % | 79 | 80 | 81 | | | |
| | Treated water-side surface pore | um | 0.13 | 0.13 | 0.18 | | | |
| | size P1 | | | | | | | |
| | Permeated water side surface | um | 0.23 | 0.36 | 0.29 | | | |
| | pore size P2 | | | | | | | |
| | A1/A2 | | 0.86 | 0.83 | 0.78 | | | |
| | A1/P1 | | 523.1 | 507.7 | 360.0 | | | |
| | P2/P1 | | 1.8 | 2.8 | 1.6 | | | |
| | Average pore size P3 | um | 0.14 | 0.12 | 0.08 | | | |
| | Maximum pore size P4 | um | 0.24 | 0.26 | 0.17 | | | |
| | P1/P3 | | 0.93 | 1.10 | 2.07 | | | |
| | Water permeability (100 kPa, 25° | m3/m2/day | 29.4 | 24.5 | 6.6 | | | |
| | C., L = 200 mm) | | | | | | | |
| | Tensile strength. | MPa | 7.2 | 7.5 | 9.7 | | | |
| | Tensile elongation. | % | 163 | 81 | 139 | | | |

| | | | | Comp | | Comp. |
|---|---|---|---|---|---|---|
| Item | | Unit | Ex. B11 | Ex. B11 | Ex. B12 | Ex. B12 |
| Conditions for producing first intermediate form | | | Ex. B6 | Ex. B6 | Ex. B1 | Ex. B1 |
| Extraction | Extracting solvent *1 | | DCM | DCM | DCM | DCM |
| on a bobbin | Rinsing agent *1 | | IPA | DCM | Ethanol | DCM |
| | | | | | → Water | |
| Stretching | Before or after Extarction | | Before | Before | After | After |
| | Stretching temperature | ° C. | 60 | 60 | 60 | 60 |
| | Stretching ratio | Times | 2.5 | 2.5 | 2.5 | 2.5 |
| Physical | Outer diameter | mm | 1.24 | Taking- | 1.44 | Stretch- |
| propertiese | Inner diameter | mm | 0.83 | out | 0.96 | ing |
| of stretched fiber | Membrane thickness | mm | 0.21 | failure | 0.24 | failure |
| | Dense layer porosity A1 | % | 64 | *4 | 64 | *3 |
| | Whole layer porosity A2 | % | 77 | | 76 | |
| | Treated water-side surface pore | um | 0.12 | | 0.09 | |
| | size P1 | | | | | |
| | Permeated water side surface | um | 0.36 | | 0.29 | |
| | pore size P2 | | | | | |
| | A1/A2 | | 0.83 | | 0.85 | |
| | A1/P1 | | 533.3 | | 727.3 | |
| | P2/P1 | | 3.0 | | 3.3 | |
| | Average pore size P3 | um | 0.12 | | <0.06 | |
| | Maximum pore size P4 | um | 0.24 | | 0.09 | |
| | P1/P3 | | 1.02 | | >1.5 | |
| | Water permeability (100 kPa, 25° | m3/m2/day | 20.3 | | 4.1 | |
| | C., L = 200 mm) | | | | | |
| | Tensile strength. | MPa | 7.7 | | 13.2 | |
| | Tensile elongation. | % | 40 | | 335 | |

*1: DCM: dichloromethane; IPA: Isopropyl alcohol
*3: Stretching was impossible because of deformation due to volumetric conraction of hollow fiber.
*4: Taking-out of wound hollow fiber was impossible because of deformation due to volumetric conraction.

[Evaluation]

In view of the above-shown Table 5, it is understood that when a halogenated solvent is removed from a vinylidene fluoride resin porous membrane containing the halogenated solvent, it becomes possible to obtain a vinylidene fluoride resin porous membrane at a high pore-formation efficiency by suppressing the contraction of pores by inserting a step of replacing the halogenated solvent for a vinylidene fluoride resin with a non-swelling solvent instead of directly drying the vinylidene fluoride resin porous membrane. Further, the results in Table 6 show that when extraction with a halogenated solvent is applied to an elongated hollow-fiber film of vinylidene fluoride resin wound about a bobbin for performing an efficient extraction, if the halogenated solvent is replaced with a non-swelling solvent, the deformation due to volumetric shrinkage of the hollow-fiber membrane is suppressed to allow easy taking-out of the hollow-fiber membrane, thereby providing a hollow-fiber porous membrane of vinylidene fluoride resin having a good water permeability regardless of small pore sizes. Such a porous membrane of vinylidene fluoride resin having a good liquid permeability is not only suitable for water filtration treatment but also suitably used as separation membranes for condensation of bacteria, protein, etc., and for recovery of the chemically flocculated particles of heavy metals, separation membranes for oil-water separation or gas-liquid separation, a separator membrane for lithium ion secondary batteries, a support membrane for solid electrolyte, etc. Particularly, a porous membrane of vinylidene fluoride resin obtained through the thermally induced phase separation process as a preferred embodiment is provided with characteristics that the pore sizes are continually expanded in the direction of the membrane thickness and the porosity is uniformly distributed in the direction of the membrane thickness, and owing to the improvement in porosity of the dense layer which contributes to separation characteristic and selective permeation characteristic, the membrane provides little resistance to movement or permeation of fluid or ions, while having excellent separation or selective permeation characteristics. Such characteristics are particularly suitable for the above-mentioned separation uses in general.

### INDUSTRIAL APPLICABILITY

As can be understood from the above Tables 1 and 2, there is provided a porous membrane of vinylidene fluoride resin which has a surface pore size, a water permeation rate and mechanical strength, particularly suitable for separation and particularly for water (filtration) treatment; and shows good water-permeation-rate maintenance performance, even when applied to continuous filtration of cloudy water, as well as a large water permeability regardless of a small pre size on the treated water-side. Although the vinylidene-fluoride-resin porous membrane of the present invention is suitable for water (filtration) treatment as mentioned above, it also has characteristics that the pore sizes are continually expanded in the direction of the membrane thickness and the porosity is uniformly distributed in the direction of the membrane thickness. Particularly, owing to the improvement in porosity of the dense layer which contributes to separation characteristic and selective permeation characteristic, the membrane provides little resistance to movement or permeation of fluid or ions, while having excellent separation or selective permeation characteristics. Accordingly, the porous membrane of the present invention can be suitably used not only for water (filtration) treatment but also as separation membranes for condensation of bacteria, protein, etc., and for recovery of the chemically flocculated particles of heavy metals, separation membranes for oil-water separation or gas-liquid separation, a separator membrane for lithium ion secondary batteries, a support membrane for solid electrolyte, etc.

1. A porous membrane of vinylidene fluoride resin, comprising a substantially single layer membrane of vinylidene fluoride resin having two major surfaces sandwiching a certain thickness, including a dense layer that has a small pore size and governs a filtration performance on one major surface side thereof, having an asymmetrical gradient network structure wherein pore sizes continuously increase from the one major surface side to the other opposite major surface side, and satisfying conditions (a) to (c) shown below:
(a) the dense layer includes a 5 μm-thick portion contiguous to the one major surface showing a porosity A1 of at least 60%,
(b) the one major surface shows a pore size P1 of at most 0.30 μm, and
(c) the porous membrane shows a ratio Q/P1⁴ of at least 5×10⁴ (m/day·m⁴), wherein the ratio Q/P1⁴ denotes a ratio between Q (m/day) which is a value normalized to a whole layer porosity A2=80% of a water permeation rate measured at a test length L=200 mm under the conditions of a pressure difference of 100 kPa and a water temperature of 25° C., and a fourth power P1⁴ of said pore size P1 on the one major surface.

2. A porous membrane according to claim 1, wherein said vinylidene fluoride resin has a weight-average molecular weight of 6×10⁵-12×10⁵.

3. A porous membrane according to claim 2, wherein said vinylidene fluoride resin is a mixture of 25-98 wt. % a vinylidene fluoride resin (PVDF-I) having a weight-average molecular weight of 4.5×10⁵-10×10⁵ and 2-75 wt. % of a vinylidene fluoride resin (PVDF-I) having a weight-average molecular weight that is at least 1.4 times that of PVDF-I and below 1.5×10⁶.

4. A porous membrane according to claim 1, showing a ratio A1/P1 of at least 400, and a ratio P2/P1 of 2.0-10.0 between a surface pore sizes P2 (um) on the other opposite major surface and P1.

5. A porous membrane according to claim 1, showing a ratio A1/A2 of at least 0.80.

6. A porous membrane according to claim 1, showing a dense layer thickness of at most 40 um.

7. A porous membrane according to claim 1, wherein said vinylidene fluoride resin shows a difference Tm2−Tc of at most 32° C. between an inherent melting point Tm2 (° C.) and a crystallization temperature Tc (° C.) of the resin as determined by DSC measurement.

8. A porous membrane according to claim 1, showing a crystallization temperature Tc of at least 143° C.

9. A porous membrane according to claim 1, wherein said vinylidene fluoride resin comprises homopolymer of vinylidene fluoride, as a whole.

10. A porous membrane according to claim 1, having an entire shape of a hollow fiber having an outer surface of the one major surface and an inner surface of the other opposite major surface.

11. A porous membrane according to claim 1, showing a tensile strength of at least 7 MPa.

12. A porous membrane according to claim 1, which has been stretched.

13. A membrane for water filtration treatment, comprising a porous membrane according to claim 1 and including a water-to-be treated side surface formed by the one major surface and a permeated water side surface formed by the other opposite major surface.

14. A process for producing a porous membrane of vinylidene fluoride resin, comprising: extruding a melt-kneaded mixture of a vinylidene fluoride resin and a plasticizer through a die into a form of a film, followed by cooling, to form a solidified film; and extracting the plasticizer to recover a porous membrane;
wherein the plasticizer is mutually soluble with the vinylidene fluoride resin at a temperature forming the melt-kneaded mixture and further satisfies properties (i) to (iii) shown below:
(i) giving the melt-kneaded mixture with the vinylidene fluoride resin with a crystallization temperature Tc′ (° C.) which is lower by at least 6° C. than a crystallization temperature Tc of the vinylidene fluoride alone,
(ii) giving the cooled and solidified product of the melt-kneaded mixture a crystal melting enthalpy ΔH′ (J/g) of at least 53 J/g per weight of the vinylidene fluoride resin as measured by a differential scanning calorimeter (DSC), and
(iii) the plasticizer alone showing a viscosity of 200 mPa-s-1000 Pa-s at a temperature of 25° C. as measured according to JIS K7117-2 (using a cone-plate-type rotational viscometer).

15. A production process according to claim 14, wherein said plasticizer is a polyester plasticizer comprising a polyester or ester of an aliphatic dibasic acid and a glycol, of which a terminal is capped with an aromatic monobasic carboxylic acid.

16. A production process according to claim 14, wherein said vinylidene fluoride resin is a mixture of 25-98 wt. % a vinylidene fluoride resin (PVDF-I) having a weight-average molecular weight of 4.5×10⁵-10×10⁵ and 2-75 wt. % of a vinylidene fluoride resin (PVDF-II) having a weight-average molecular weight that is at least 1.4 times that of PVDF-I and below 1.5×10⁶.

17. A production process according to claim 14, wherein the extruded film of said melt-kneaded mixture is cooled with an inert liquid preferentially from one surface thereof to be solidified.

18. A production process according to claim 14, wherein said melt-kneaded mixture is extruded into a hollow-fiber film, and the hollow-fiber film is cooled with an inert liquid preferentially from an outer surface thereof to be solidified.

19. A production process according to claim 17, wherein said melt-kneaded mixture has a Tc′ giving a difference Tc′-Tq of 50-140° C. with a temperature Tq (° C.) of the cooling inert liquid.

20. A production process according to claim 14, wherein said melt-kneaded mixture has a Tc′ of 120-140° C.

21. A production process according to claim 14, wherein the solidified film of said melt-kneaded mixture is immersed in a halogenated solvent to extract the plasticizer and, without being substantially dried, the solidified film containing the halogenated solvent is immersed in a solvent exhibiting no swelling power to the vinylidene fluoride resin to replace the halogenated solvent and then dried.

22. A production process according to claim 14, wherein the porous membrane after extraction of the plasticizer is stretched in a state where the porous membrane is wetted to a depth which at least 5 μm and at most ½ of the thickness thereof.
